(19) United States
(12) Patent Application Publication
(10) Pub. No.: US 2003/0033213 A1
(43) Pub. Date: Feb. 13, 2003

(54) System for acquiring goods and/or services

(76) Inventor: Carmi Bogot, Maale Adumim (IL)

Correspondence Address: S Peter Ludwig, Darby & Darby, 805 Third Avenue, New York, NY, 10022-7513, US

(21) Appl. No.: 10/129,218

(22) PCT Filed: Mar. 26, 2001
(86) PCT No.: PCT/IL01/00282

(51) Int. Cl. G06F 17/60

(52) U.S. Cl. 705/26

(57) ABSTRACT

In an environment including a television (110) hand held by a use (115) an including at least one directional control (130), a method for acquisition of goods or services including selecting goods or services by employing only the at least one direction control (130), and completing a transaction for selected goods or services by employing only the at least one direction control (130) and other related methods as disclosed.

### FIELD OF THE INVENTION

The present invention relates to electronic commerce in general, and in particular to electronic commerce via television.

### BACKGROUND OF THE INVENTION

Electronic commerce, known as e-commerce, particularly via the Internet, is well known in the art.

It has been suggested to provide electronic commerce via television; this is known as television commerce or t-commerce.

The following publications may be relevant to understanding the background of the present invention:

U.S. Pat. No. 5,199,080 to Kimura et al. describes a voice-operated remote control system which contains a speech recognition circuit that recognizes a voice command. A remote control signal is sent in response to a voice command. A standard pattern data storage unit is used to store a plurality of standard pattern data with respect to each of voice commands in the speech recognition circuit. The plural standard pattern data for accurate speech recognition is compared with the input voice command.

U.S. Pat. No. 5,226,090 to Kimura describes a voice-operated remote control system. In response to a voice command, this system transmits a remote control signal. The system also contains a detector for detecting whether a voice command has been received. A detected signal is applied to a power supply control circuit. When the detector has not received a voice command, electric energy supplied to a speech recognition circuit is cut by the power supply control circuit. A remotely controlled device can repeat an operation when sent a repetition command by a continuous operation instruction unit contained in the voice operated remote control system. The instruction signal is supplied to a continuous operation control unit. The continuous operation control unit adds the repetition command to the remote control signal which is transmitted to the remotely controlled device.

U.S. Pat. Nos. 5,539,450 and 5,592,212 to Handelman describe a pay television gaming system. This system includes a pay television network, which has a multiplicity of subscriber units. Each subscriber unit includes a television, a receiving apparatus, a transmitting apparatus, and an accounting apparatus. The receiving apparatus of each subscriber unit receives gaming inputs from the multiplicity of subscriber units. The transmitting apparatus of each subscriber unit transmits gaming results data to the multiplicity of subscriber units. The accounting apparatus of each subscriber unit settles gaming debts and winnings via the pay television network. Other services such as shopping may also be provided.

Published PCT Patent Application WO 98/16062 describes a remote control devices which includes a speaker and a display screen. The remote control device receives and stores transmitted television program information. This information preferably includes an electronic program guide and is preferably transmitted via a wireless paging system at a preferred frequency of about 900 MHz. The remote control device includes a digital signal processor, which sorts and stores the retrieved program information. A viewer command input through a keypad on the remote control device elicits a response in which the microcontroller selectively retrieves and displays at least part of the program information on the display. As the viewer changes channels or scrolls through the electronic program guide, the display changes. A voice message function is also included in the remote control device. The microcontroller retrieves and processes a voice message for announcement through the speaker when the voice message function is activated. The voice message is related to the currently displayed television program on an associated television system or to a program selected in the electronic program guide.

### SUMMARY OF THE INVENTION

The present invention seeks to provide an improved system for electronic commerce via television. The present invention includes methods, apparatus, user interfaces, and related elements. Persons skilled in the art will appreciate, for example, that when user interfaces are mentioned, related methods are also appreciated to exist and to be contemplated as part of the present invention; when apparatus is mentioned, related methods are appreciated to exist and to be contemplated as part of the present invention; and so forth.

The present invention is directed, in preferred embodiments thereof, to providing an improved user interface for t-commerce. In the prior art of Internet e-commerce, a full keyboard and usually a mouse are provided for user interaction with a user interface. In preferred embodiments, it is a feature of the present invention that the user interface is particularly adapted for ease of use with a remote control. In some embodiments, the user interface is particularly adapted to suit the needs of vendors of t-commerce goods or services. Appropriate combinations are contemplated as part of the invention.

Preferably, the various embodiments of the present invention may be used for purchase and non-purchase transactions including gambling services, betting services, gaming services, financial services, educational services, information retrieval services, entertainment services and transportation services. Selecting and completing a transaction may be effected in a single user action or in multiple user actions. Non-direction controls, as further described below, may include any control which is not directional, for example numerical controls and a select control. Non-numerical non-direction controls, as further described below, may include any control which is not directional and not numerical, for example, color controls and a select control.

There is thus provided in accordance with a preferred embodiment of the present invention, in an environment including a television and a remote control unit hand held by a user and including at least one direction control, a method for acquisition of goods or services including selecting goods or services by employing only the at least one direction control, and completing a transaction for selected goods or services by employing only the at least one direction control.

Further in accordance with a preferred embodiment of the present invention the transaction is a purchase transaction.

Still further in accordance with a preferred embodiment of the present invention the transaction is a non-purchase transaction.

Additionally in accordance with a preferred embodiment of the present invention the services include at least one of gambling services, betting services, gaming services, financial services, educational services, information retrieval services, entertainment services, and transportation services.

Moreover in accordance with a preferred embodiment of the present invention the selecting and completing are effected in a single user action.

Further in accordance with a preferred embodiment of the present invention the selecting and completing are effected in multiple user actions.

There is also provided in accordance with another preferred embodiment of the present invention, in an environment including a television and a remote control unit hand held by a user and including at least one non-numerical non-direction control, a method for acquisition of goods or services including selecting goods or services by employing only the at least one non-numerical non-direction control, and completing a transaction for selected goods or services by employing only the at least non-numerical non-direction control.

Further in accordance with a preferred embodiment of the present invention the transaction is a purchase transaction.

Still further in accordance with a preferred embodiment of the present invention the transaction is a non-purchase transaction.

Additionally in accordance with a preferred embodiment of the present invention the services include at least one of gambling services, betting services, gaming services, financial services, educational services, information retrieval services, entertainment services, and transportation services.

Moreover in accordance with a preferred embodiment of the present invention the selecting and completing are effected in a single user action.

Further in accordance with a preferred embodiment of the present invention the selecting and completing are effected in multiple user actions.

There is also provided in accordance with another preferred embodiment of the present invention, in an environment comprising a television and a remote control unit hand held by a user and including at least one numerical control, a method for acquisition of goods or services including selecting goods or services by employing only the at least one numerical control, and completing a transaction for selected goods or services by employing only the at least one numerical control.

Further in accordance with a preferred embodiment of the present invention the transaction is a purchase transaction.

Still further in accordance with a preferred embodiment of the present invention the transaction is a non-purchase transaction.

Additionally in accordance with a preferred embodiment of the present invention the services include at least one of gambling services, betting services, gaming services, financial services, educational services, information retrieval services, entertainment services, and transportation services.

Moreover in accordance with a preferred embodiment of the present invention the selecting and completing are effected in a single user action.

Further in accordance with a preferred embodiment of the present invention selecting and completing are effected in multiple user actions.

There is also provided in accordance with another preferred embodiment of the present invention, in an environment including a television and a remote control unit hand held by a user and including at least one direction control and at least one non-direction control, a method for acquisition of goods or services including selecting goods or services by employing only at least one of the at least one direction control and the at least one non-direction control, and completing a transaction for selected goods or services by employing only at least one of the at least one direction control and the at least one non-direction control.

Further in accordance with a preferred embodiment of the present invention the transaction is a purchase transaction.

Still further in accordance with a preferred embodiment of the present invention the transaction is a non-purchase transaction.

Additionally in accordance with a preferred embodiment of the present invention the non-direction control is a select control.

Moreover in accordance with a preferred embodiment of the present invention the services include at least one of gambling services, betting services, gaming services, financial services, educational services, information retrieval services, entertainment services, and transportation services.

There is also provided in accordance with another preferred embodiment of the present invention, in an environment including a television and a remote control unit hand held by a user and including at least one direction control, at least one non-numerical non-direction control and a plurality of numerical designated keys, a method for acquisition of goods or services and viewing television content including acquiring goods or services by employing at least one of the at least one direction control and the at least one non-numerical non-direction control, and employing the plurality of numerical designated keys for television selection and not for purchase of goods or services.

Further in accordance with a preferred embodiment of the present invention the acquiring is a purchase transaction.

Still further in accordance with a preferred embodiment of the present invention the acquiring is a non-purchase transaction.

Additionally in accordance with a preferred embodiment of the present invention the non-numerical non-direction control is a select control.

Moreover in accordance with a preferred embodiment of the present invention the services include at least one of gambling services, betting services, gaming services, financial services, educational services, information retrieval services, entertainment services, and transportation services.

There is also provided in accordance with another preferred embodiment of the present invention, in an environment including a television and a remote control unit hand held by a user and including at least one direction control and at least one non-numerical non-direction control, a method for acquisition of goods or services including acquiring goods or services by providing a user interface for a user engaging at least one of the at least one direction control and the at least one non-numerical non-direction control a plurality of times in a sequence including at least: A: at least one engagement of one of the at least one direction control and the at least one non-numerical non-direction control, followed by B: at least one engagement of one of the at least one direction control and the at least one non-numerical non-direction control, and C: at least zero transitions between engagement between different ones of the at least one of the at least one direction control and the at least one non-numerical non-direction control, the user interface being characterized in that a number of the transitions is minimized at the expense of non-minimization of a number of the engagements.

Further in accordance with a preferred embodiment of the present invention the acquisition is a purchase transaction.

Still further in accordance with a preferred embodiment of the present invention the acquisition is a non-purchase transaction.

Additionally in accordance with a preferred embodiment of the present invention the non-numerical non-direction control is a select control.

Moreover in accordance with a preferred embodiment of the present invention the services include at least one of gambling services, betting services, gaming services, financial services, educational services, information retrieval services, entertainment services, and transportation services.

There is also provided in accordance with another preferred embodiment of the present invention, in an environment including a television and a remote control unit hand held by a user and including at least one direction control and at least one non-numerical non-direction control, a method for acquisition of goods or services and viewing television content including acquiring goods or services by providing a user interface for a user engaging at least one of the at least one direction control and the at least one non-numerical non-direction control a plurality of times in a sequence including at least A: at least one engagement of one of the at least one direction control and the at least one non-numerical non-direction control, followed by B: at least one engagement of one of the at least one direction control and the at least one non-numerical non-direction control, and C: at least zero transitions between engagement between different ones of the at least one of the at least one direction control and the at least one non-numerical non-direction control, the user interface being characterized in that time required by a user in order to effect acquisition is minimized at the expense of non-minimization of a number of the engagements.

Further in accordance with a preferred embodiment of the present invention the acquisition is a purchase transaction.

Still further in accordance with a preferred embodiment of the present invention the acquisition is a non-purchase transaction.

Additionally in accordance with a preferred embodiment of the present invention the non-numerical non-direction control is a select control.

Moreover in accordance with a preferred embodiment of the present invention the services include at least one of gambling services, betting services, gaming services, financial services, educational services, information retrieval services, entertainment services, and transportation services.

There is also provided in accordance with another preferred embodiment of the present invention, in an environment including a television and a remote control unit hand held by a user and including at least one direction control and at least one non-numerical non-direction control, a method for acquisition of goods or services and viewing television content including acquiring goods or services by providing a user interface for a user engaging at least one of the at least one direction control and the at least one non-numerical non-direction control a plurality of times in a sequence including at least A: at least one engagement of one of the at least one direction control and the at least one non-numerical non-direction control, followed by B: at least one engagement of one of the at least one direction control and the at least one non-numerical non-direction control, and C: at least zero transitions between engagement between different ones of the at least one of the at least one direction control and the at least one non-numerical non-direction control, the user interface being characterized in that the goods or services are ranked by a provider in accordance with a provider's priority, and ease of acquisition by a user engaging the at least one of the at least one direction control and the at least one non-numerical non-direction control a plurality of times in the sequence for at least some of the goods or services corresponding to the provider's priorities associated therewith.

Further in accordance with a preferred embodiment of the present invention the acquisition is a purchase transaction.

Still further in accordance with a preferred embodiment of the present invention the acquisition is a non-purchase transaction.

Additionally in accordance with a preferred embodiment of the present invention the non-numerical non-direction control is a select control.

Moreover in accordance with a preferred embodiment of the present invention the provider's priorities are based on economic benefit to the provider.

Further in accordance with a preferred embodiment of the present invention the provider's priorities are based on an expected statistical preference of the user.

Further in accordance with a preferred embodiment of the present invention the user interface is configured such that goods or services having high provider's priorities can be acquired by a user without engaging the at least one direction control.

Still further in accordance with a preferred embodiment of the present invention the user interface is configured such that goods or services having high provider's priorities can be acquired by a user with minimized engagement of the at least one direction control.

Additionally in accordance with a preferred embodiment of the present invention the services include at least one of gambling services, betting services, gaming services, financial services, educational services, information retrieval services, entertainment services, and transportation services.

There is also provided in accordance with a preferred embodiment of the present invention, in an environment including a television and a remote control unit hand held by a user and including at least one direction control and at least one non-numerical non-direction control, a method for acquisition of goods or services and viewing television content including acquiring goods or services by providing a user interface for a user engaging at least one of the at least one direction control and the at least one non-numerical non-direction control a plurality of times in a sequence including at least A: at least one engagement of one of the at least one direction control and the at least one non-numerical non-direction control, followed by B: at least one engagement of one of the at least one direction control and the at least one non-numerical non-direction control, and C: at least zero transitions between engagement between different ones of the at least one of the at least one direction control and the at least one non-numerical non-direction control, the user interface being characterized in that the goods or services are ranked by a provider in accordance with a provider's priority, and goods or services having high provider's priorities can be acquired by a user by engagement of only one of the at least one direction control and the at least one non-numerical non-direction control.

Further in accordance with a preferred embodiment of the present invention the acquisition is a purchase transaction.

Still further in accordance with a preferred embodiment of the present invention the acquisition is a non-purchase transaction.

Moreover in accordance with a preferred embodiment of the present invention the non-numerical non-direction control is a select control.

Further in accordance with a preferred embodiment of the present invention the provider's priorities are based on economic benefit to the provider.

Still further in accordance with a preferred embodiment of the present invention the provider's priorities are based on an expected statistical preference of the user.

Additionally in accordance with a preferred embodiment of the present invention the services include at least one of gambling services, betting services, gaming services, financial services, educational services, information retrieval services, entertainment services, and transportation services.

There is also provided in accordance with another preferred embodiment of the present invention, in an environment including a television and a remote control unit hand held by a user, a method for acquisition of goods or services including selecting goods or services by the user employing the remote control unit, and completing a transaction for selected goods or services at least partially by the user speaking.

Further in accordance with a preferred embodiment of the present invention the completing includes the user engaging in interactive voice communication with a synthesized speech source.

Still further in accordance with a preferred embodiment of the present invention the synthesized speech source is incorporated in a set top box.

Additionally in accordance with a preferred embodiment of the present invention the synthesized speech source is incorporated in the television.

Further in accordance with a preferred embodiment of the present invention the completing includes the user engaging in interactive voice communication with a human via a telephone.

Still further in accordance with a preferred embodiment of the present invention the interactive voice communication is initiated other than by the user dialing a telephone call.

Additionally in accordance with a preferred embodiment of the present invention the interactive voice communication is initiated by an operator dialing a telephone call to the user.

Further in accordance with a preferred embodiment of the present invention, interactive voice communication is initiated other than by an operator dialing a telephone call to the user.

Still further in accordance with a preferred embodiment of the present invention the interactive voice communication is initiated by an automatic call back system in response to a user command.

Moreover in accordance with a preferred embodiment of the present invention the user speaking provides transaction information other than selection of the goods or services.

Further in accordance with a preferred embodiment of the present invention the user speaking provides transaction information related to a delivery address.

Still further in accordance with a preferred embodiment of the present invention the method also includes the step of storing transaction information received as a result of the user speaking.

Additionally in accordance with a preferred embodiment of the present invention the method also includes displaying at least some of the transaction information received, as a result of the user speaking, on the television.

Moreover in accordance with a preferred embodiment of the present invention the method also includes obtaining user confirmation of the correctness of the transaction information received, as a result of the user speaking, on the television following display thereof on the television.

### BRIEF DESCRIPTION OF THE DRAWINGS

The present invention will be understood and appreciated more fully from the following detailed description, taken in conjunction with the drawings in which:

FIGS. 1A-1E comprise a sequence of pictorial illustrations showing a system, and operation of the system, for performing a method for acquisition of goods and services, constructed and operative in accordance with a preferred embodiment of the present invention;

FIGS. 2A-2E comprise a sequence of pictorial illustrations showing a system, and operation of the system, for performing a method for acquisition of goods and services, constructed and operative in accordance with an alternative preferred embodiment of the present invention;

FIGS. 3A-3G comprise a sequence of pictorial illustrations showing a system, and operation of the system, for performing a method for acquisition of goods and services and viewing television content, constructed and operative in accordance with another alternative preferred embodiment of the present invention;

FIGS. 4A-4E comprise a sequence of pictorial illustrations showing a system, and operation of the system, for performing a method for acquisition of goods and services, constructed and operative in accordance with still another alternative preferred embodiment of the present invention;

FIGS. 5A-5E comprise a sequence of pictorial illustrations showing a system, and operation of the system, for performing a method for acquisition of goods and services, constructed and operative in accordance with yet another alternative preferred embodiment of the present invention;

FIGS. 6A-6F comprise a sequence of pictorial illustrations showing a system, and operation of the system, for performing a method for acquisition of goods and services, constructed and operative in accordance with a still further alternative preferred embodiment of the present invention;

FIGS. 7A-7D comprise a sequence of pictorial illustrations showing a system, and operation of the system, for performing a method for acquisition of goods and services, constructed and operative in accordance with another alternative preferred embodiment of the present invention;

FIGS. 8A-8F comprise a sequence of pictorial illustrations showing a system, and operation of the system, for performing a method for acquisition of goods and services, constructed and operative in accordance with a still further alternative preferred embodiment of the present invention;

FIG. 9 is a simplified flowchart illustration of a preferred method of operation of the system of FIGS. 1A-1E;

FIG. 10 is a simplified flowchart illustration of a preferred method of operation of the system of FIGS. 2A-2E;

FIG. 11 is a simplified flowchart illustration of a preferred method of operation of the system of FIGS. 3A-3G;

FIG. 12 is a simplified flowchart illustration of a preferred method of operation of the systems of FIGS. 4A-4E and 5A-SE;

FIG. 13 is a simplified flowchart illustration of an alternative preferred method of operation of the systems of FIGS. 4A-4E and 5A-5E;

FIG. 14 is a simplified flowchart illustration of another alternative preferred method of operation of the systems of FIGS. 4A-4E and 5A-5E;

FIG. 15 is a simplified flowchart illustration of still another preferred method of operation of the systems of FIGS. 4A-4E and 5A-5E; and

FIG. 16 is a simplified flowchart illustration of a preferred method of operation of the systems of FIGS. 6A-6F, 7A-7D, and 8A-8F.

### DETAILED DESCRIPTION OF A PREFERRED EMBODIMENT

In the drawings of the present application, similar reference numbers are used to refer to similar elements. For the sake of brevity and clarity of description, repeated description of similar elements is generally omitted.

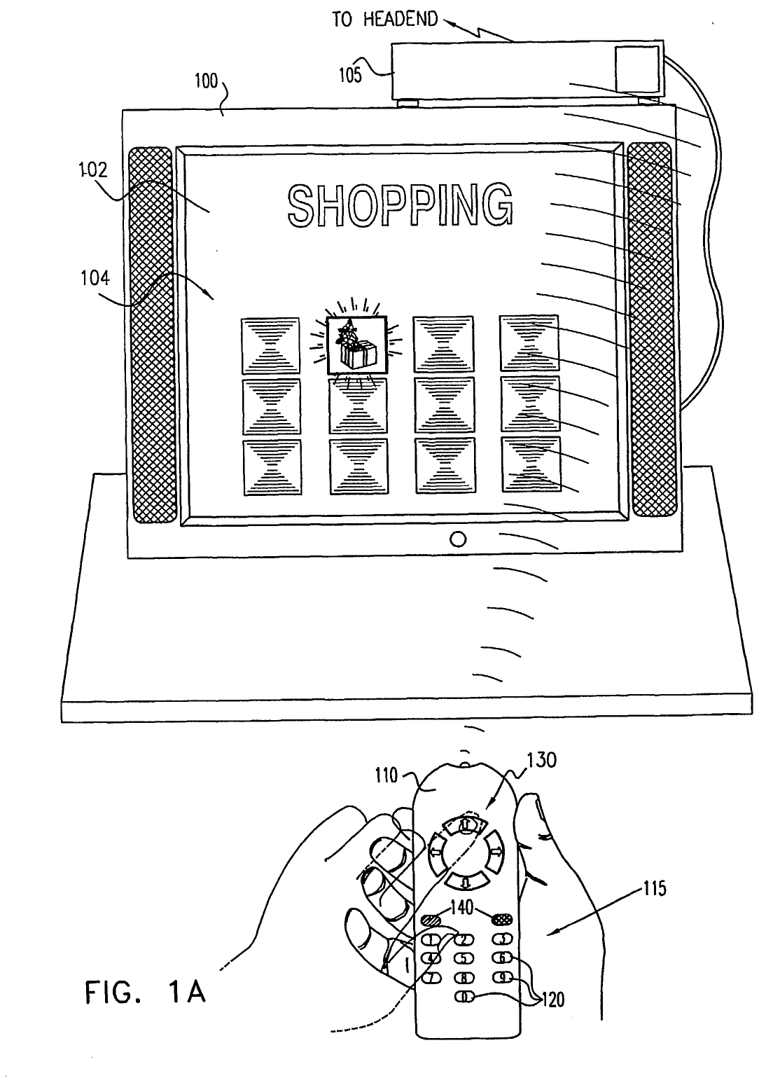

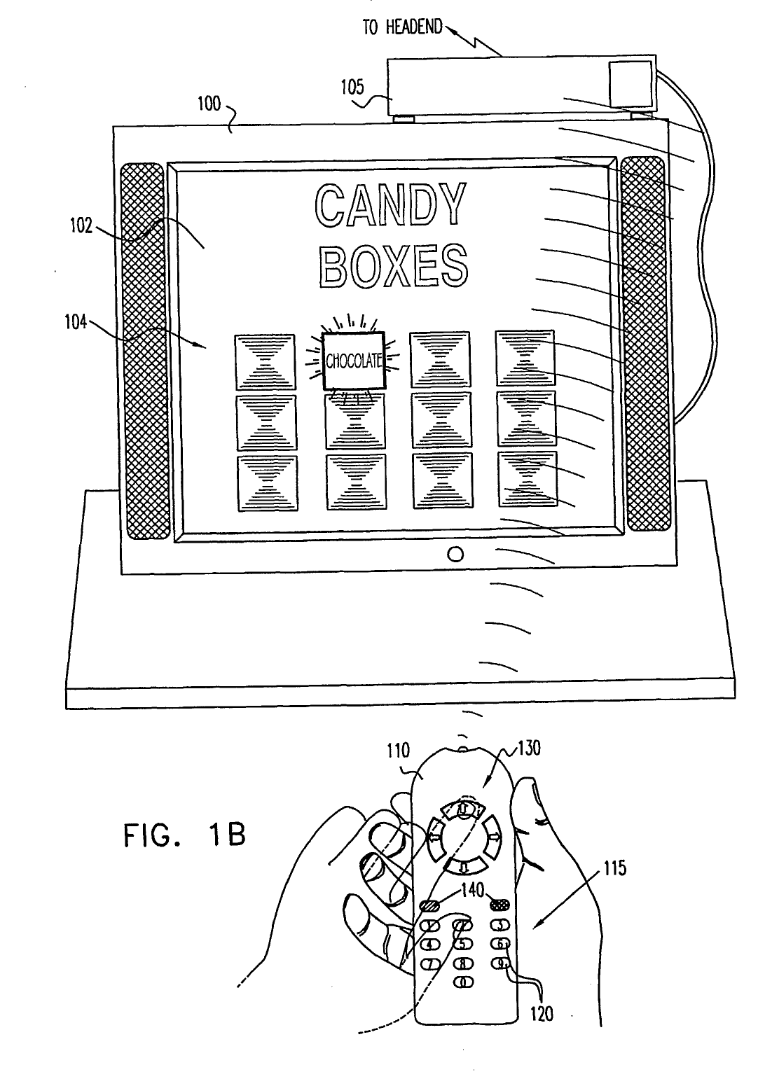

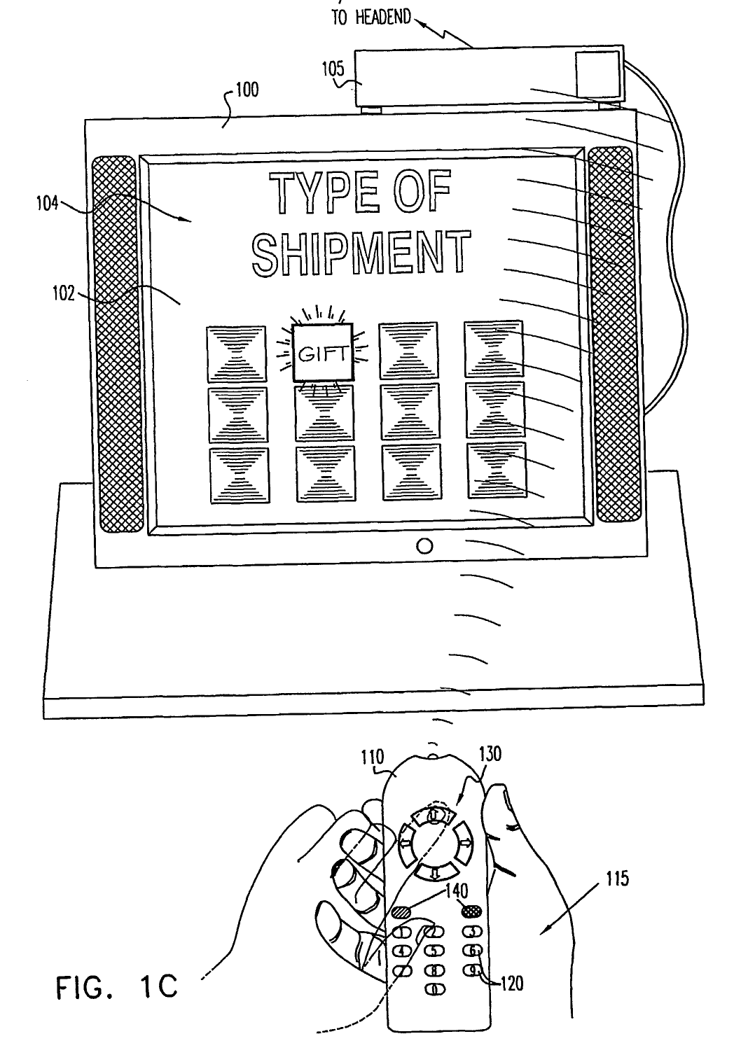

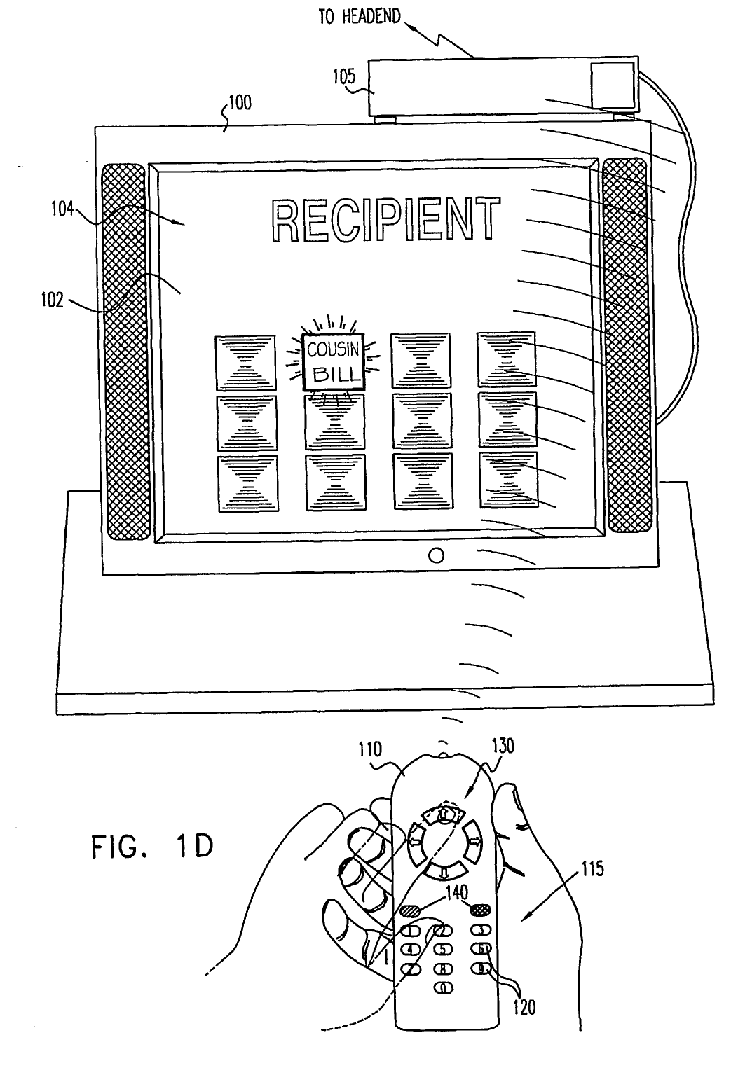

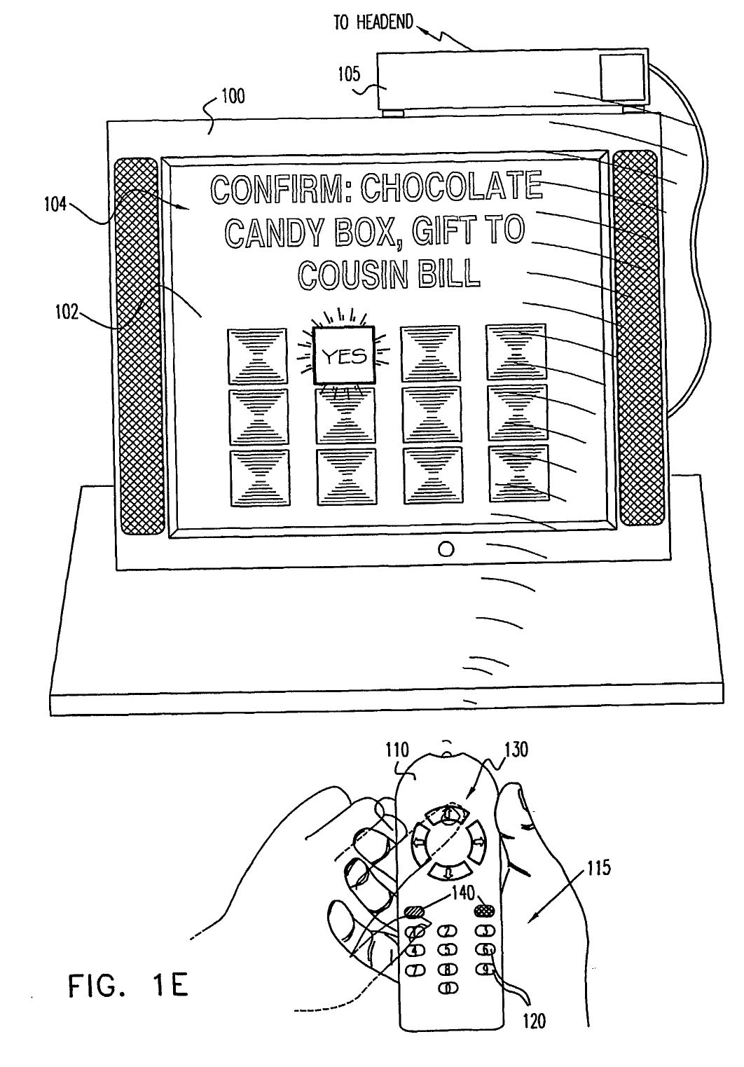

Reference is now made to FIGS. 1A-1E which comprise a sequence of pictorial illustrations showing a system, and operation of the system, for performing a method for acquisition of goods and services, constructed and operative in accordance with a preferred embodiment of the present invention.

The system of FIG. 1A preferably comprises a television 100, which may comprise any appropriate television as is well known in the art. The television 100 comprises, inter alia, a display screen 102, as is well known in the art. Shown on the display screen 102 is a user interface 104, described in more detail below.

The system of FIG. 1A also preferably comprises a set top box (STB) 105, which may comprise any appropriate set top box or integrated receiver/decoder (IRD), as is well known in the art, suitably programmed to provide a user interface as described herein. It is appreciated that: the STB 105 may or may not include a removable security element such as a smart card; and the functionality of the STB 105 may alternatively be included within the television 100, in which case the STB 105 may be omitted. Throughout the present description and drawings, it will be appreciated that when the STB 105 is not explicitly shown in a drawing, the functionality of the STB 105 is understood to be included within the television 100 in the preferred embodiment to which the particular drawing belongs.

As is well known in the art, the STB 105 is preferably operatively associated with the television 100 and is preferably operative to receive and, where appropriate, decode television transmissions.

Preferably, as is also well known in the art, the STB 105 is equipped with a return path or other ability to communicate with a broadcaster, a broadcaster headend, or another appropriate location (not shown). Shown in FIG. 1A, by way of example only, is a return path to a headend, it being appreciated that any other appropriate return path may be used.

It is well known in the art that various types of return path are available, and that an appropriate return path should be chosen. For example, in the case of a cable broadcast, where the STB 105 is appropriate for receiving cable broadcasting, the return path may comprise a cable return path. In the case of a satellite broadcast, where the STB 105 is appropriate for receiving satellite broadcasting, the return path may comprise a telephone return path, also known as a “telephone link”. It is appreciated that other technologies for implementing a return path, including but not limited to VSAT satellite return path technology, are known, and that any appropriate return path may be used.

Preferably, the STB 105 is operative to receive commands from a remote control 110, as is also well known in the art, the remote control 110 being preferably included in the system of FIG. 1A. The remote control 110 preferably comprises a plurality of controls 115, shown conventionally as control buttons in FIG. 1A, it being appreciated that any other appropriate form of controls, including but not limited to computer mouse type controls or computer trackball type controls, may also be used.

The plurality of controls 115 preferably comprises at least one numerical control 120, typically comprising a plurality of numerical controls which may be numbered as shown in FIG. 1A or otherwise labeled, which may be arranged in FIG. 1A or arranged otherwise, and which may generally be similar to numerical controls for a remote control as are known in the art.

The plurality of controls 115 preferably also comprises at least one direction control 130. For example, and without limiting the generality of the foregoing, it is known in the art to use joystick, trackball, annular direction controls or any other appropriate direction control. Shown in FIG. 1A, by way of example only, are four direction controls labeled with four arrows indicating four directions, it being appreciated that any other appropriate direction control or plurality of direction controls may be used.

The plurality of controls 115 preferably also comprises at least one non-direction non-numerical control 140. For example, and without limiting the generality of the foregoing, it is known in the art to use colored buttons such as, for example, red buttons and blue buttons, as non-numerical non-direction controls. Shown in FIG. 1A, by way of example only, are two colored controls, it being appreciated that other types of non-direction non-numerical controls, as are known in the art, and one or a plurality of such controls, may be used.

The remote control 110 may comprise any appropriate remote control device suitable for use with the STB 105; for example, if the STB 105 is adapted to receive infrared control signals of a certain type, the remote control 110 is preferably adapted to produce signals of that type.

The operation of the system of FIGS. 1A-1E is now briefly described. The system of FIGS. 1A-1E includes a user interface 104, in which a user interacts with the television 100 via the remote control 110; user interfaces of this general type are well known in the art. In FIGS. 1A-1E, the user interface 104 allows the user to acquire goods or services using only one direction control 130, it being appreciated that the user might alternatively use only a plurality of direction controls 130.

It is further appreciated that a transaction can be completed with only one non-numerical non-direction control or only with a plurality of non-numerical non-direction controls. It is still further appreciated that a transaction can be completed with only one numerical control or only with a plurality of numerical controls. The preceding list of alternatives is provided by way of example only and is not meant to be limiting.

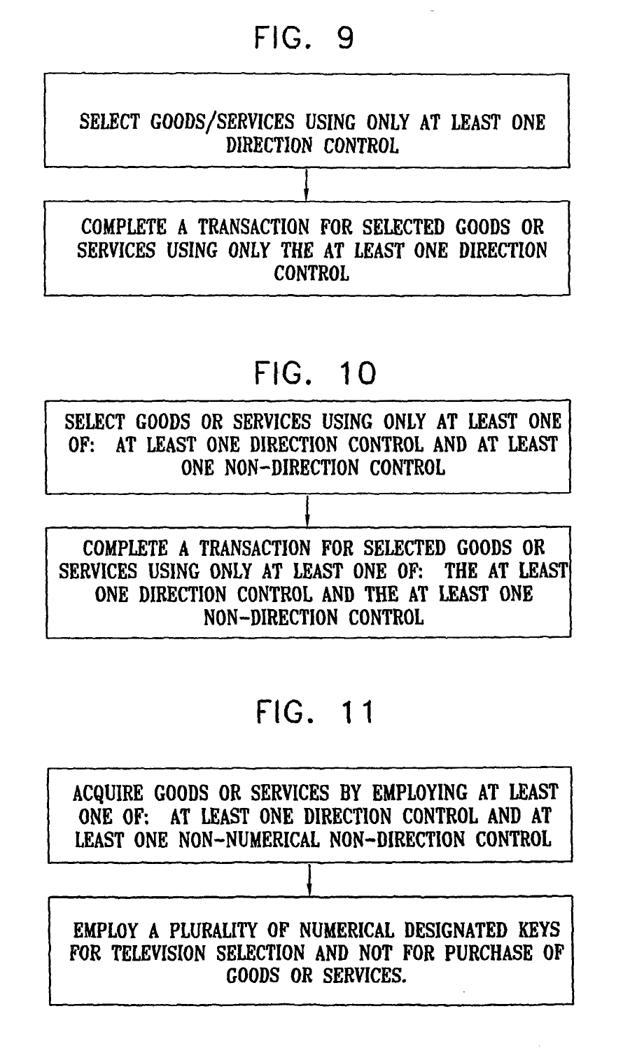

Reference is now additionally made to FIG. 9, which is a simplified flowchart illustration of a preferred method of operation of the system of FIGS. 1A-1E. The method of FIG. 9 is self-explanatory with reference to the above description.

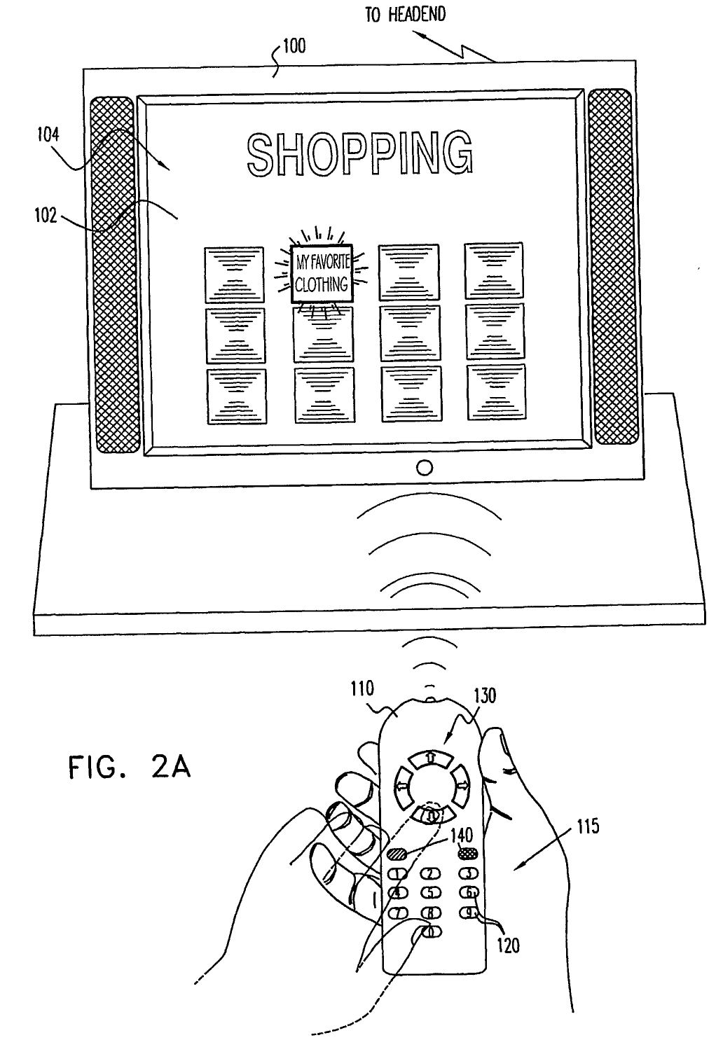

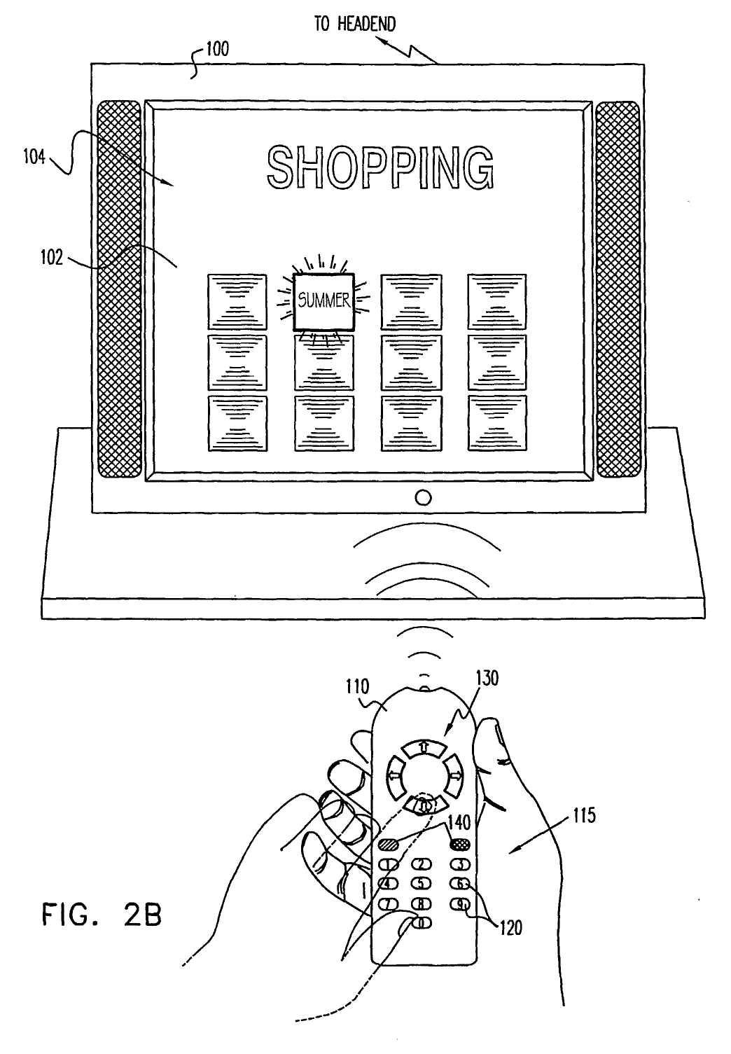

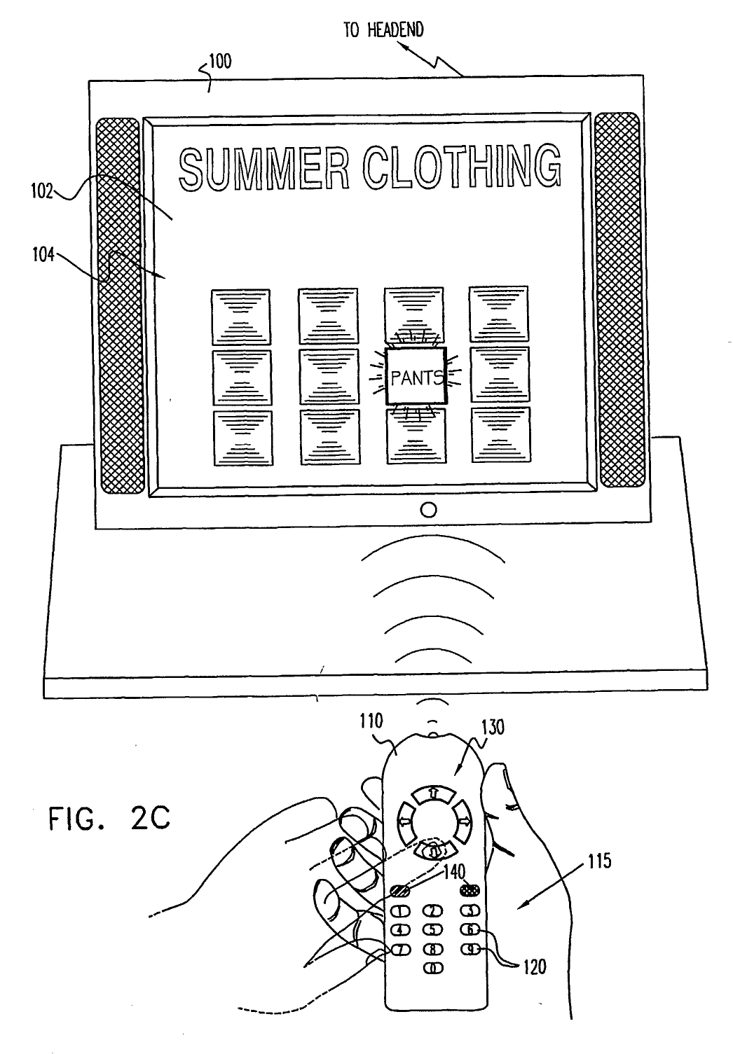

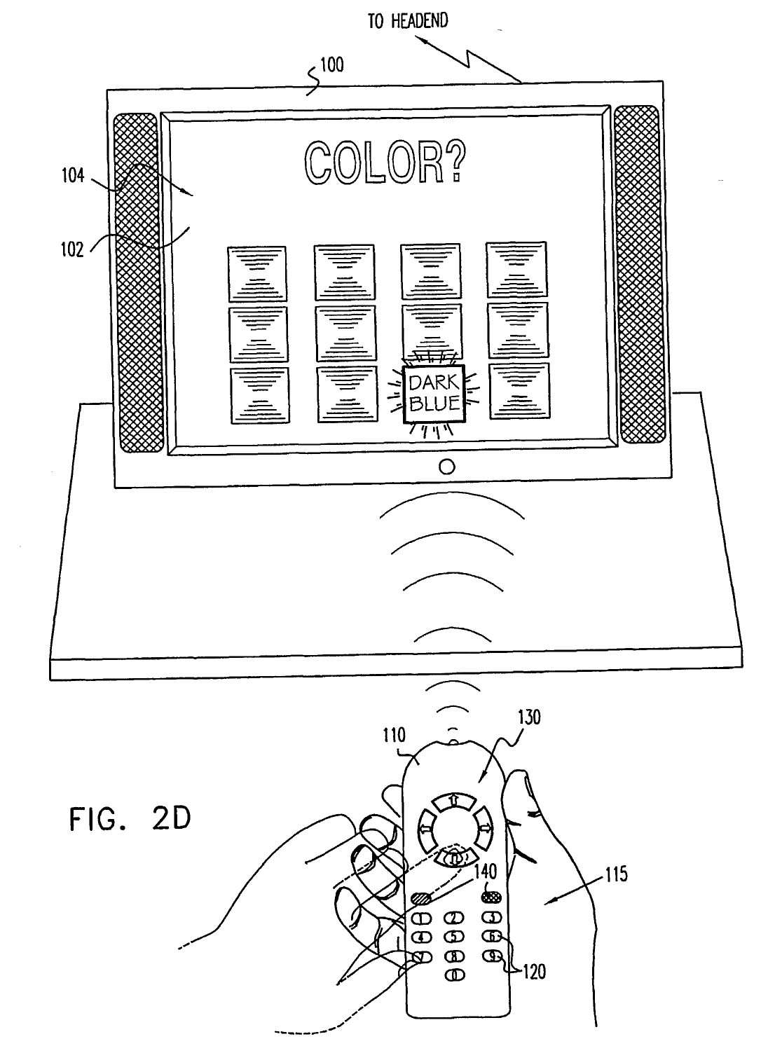

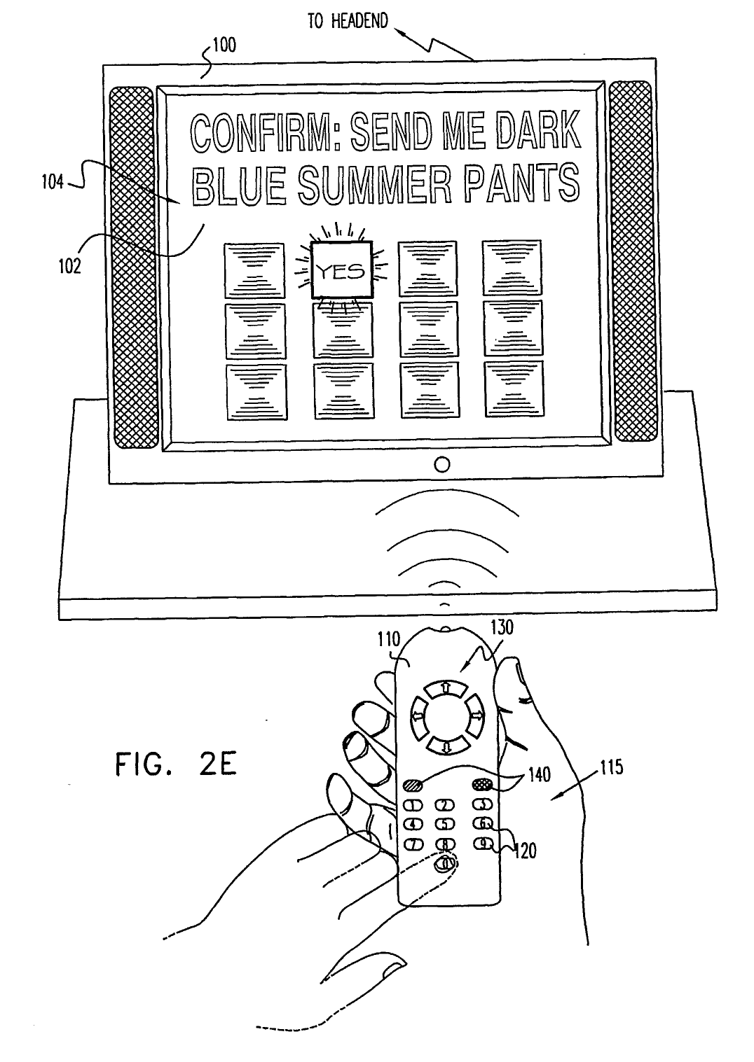

Reference is now made to FIGS. 2A-2E, which comprise a sequence of pictorial illustrations showing a system, and operation of the system, for performing a method for acquisition of goods and services, constructed and operative in accordance with an alternative preferred embodiment of the present invention. The system of FIGS. 2A-2E is similar to the system of FIGS. 1A-1E, except as described below.

The operation of the system of FIGS. 2A-2E is now briefly described. The system of FIGS. 2A-2E includes a user interface 104, in which a user interacts with the television 100 via the remote control 110; user interfaces of this general type are well known in the art. Goods and services are selected by employing only at least one of: at least one direction control and at least one non-direction control. The transaction for selected goods or services is completed by using only at least one of: the at least one direction control and the at least one non-direction control.

In FIGS. 2A-2E, the user interface 104 allows the user to acquire goods or services using only one direction control 130 and to complete the transaction using one non-direction control, comprising in the example of FIGS. 2A-2E a numerical control 120. It is appreciated that the user might alternatively use a plurality of direction controls 130 to acquire goods or services. It is appreciated that other non-direction controls which are non-numerical may alternatively be used.

In the system of FIGS. 2A-2E, it is appreciated that other actuation sequences may alternatively be used. The sequences shown in FIGS. 2A-2E are examples only and are not meant to be limiting.

Reference is now additionally made to FIG. 10, which is a simplified flowchart illustration of a preferred method of operation of the system of FIGS. 2A-2E. The method of FIG. 10 is self-explanatory with reference to the above description.

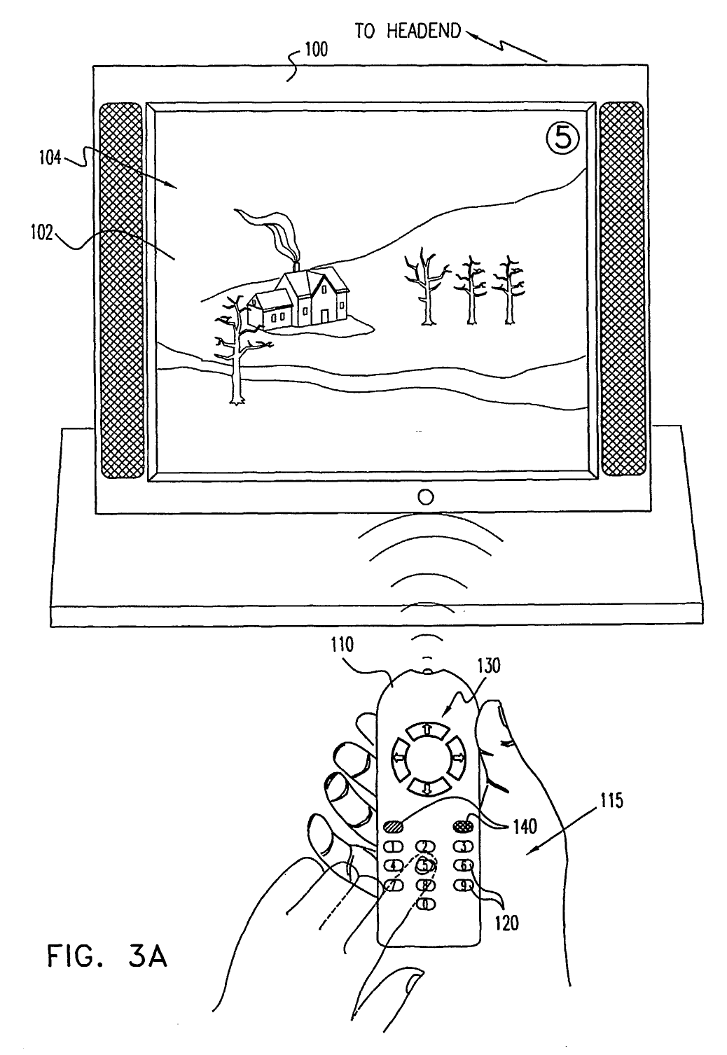

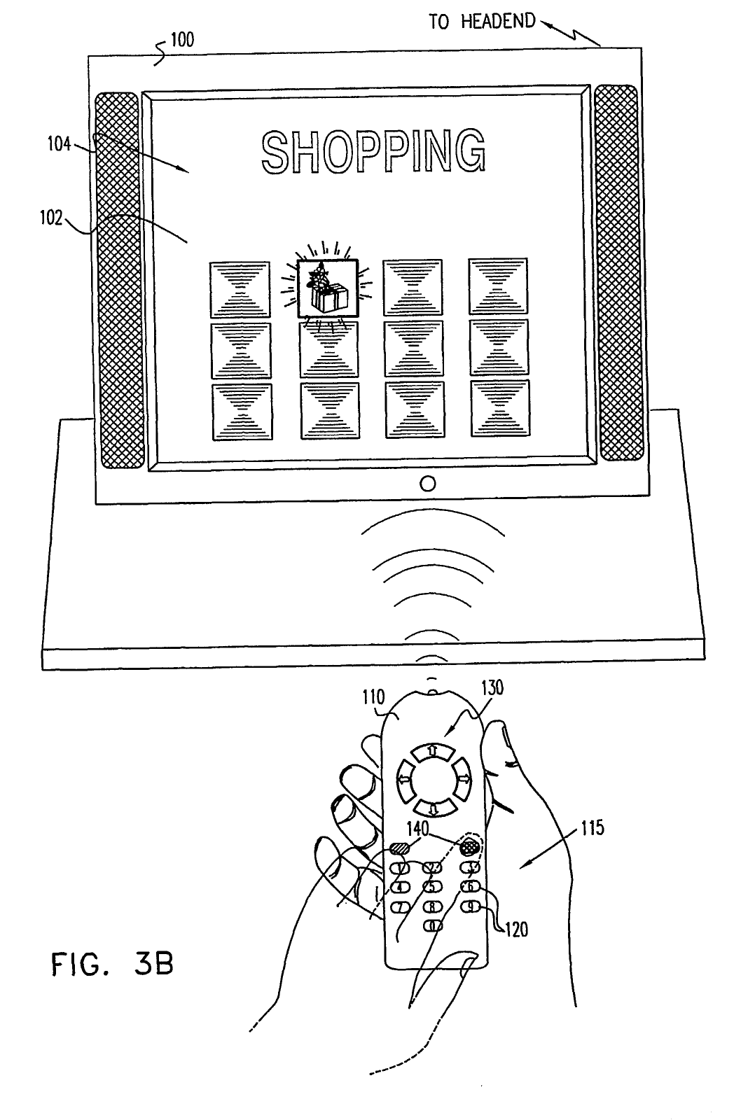

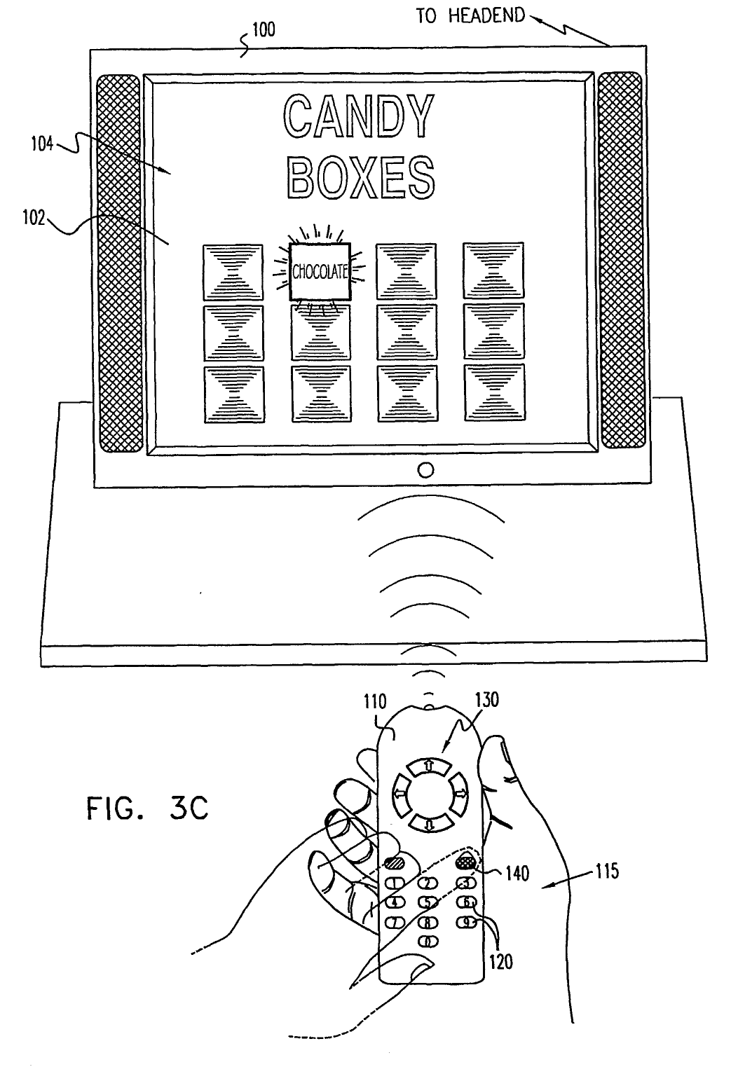

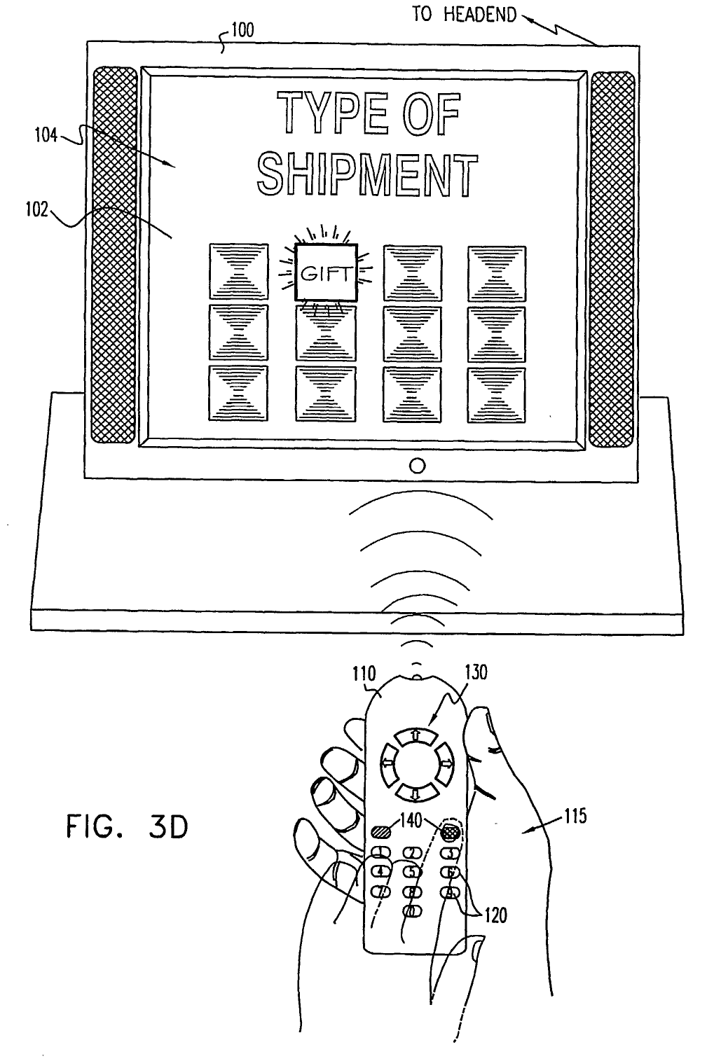

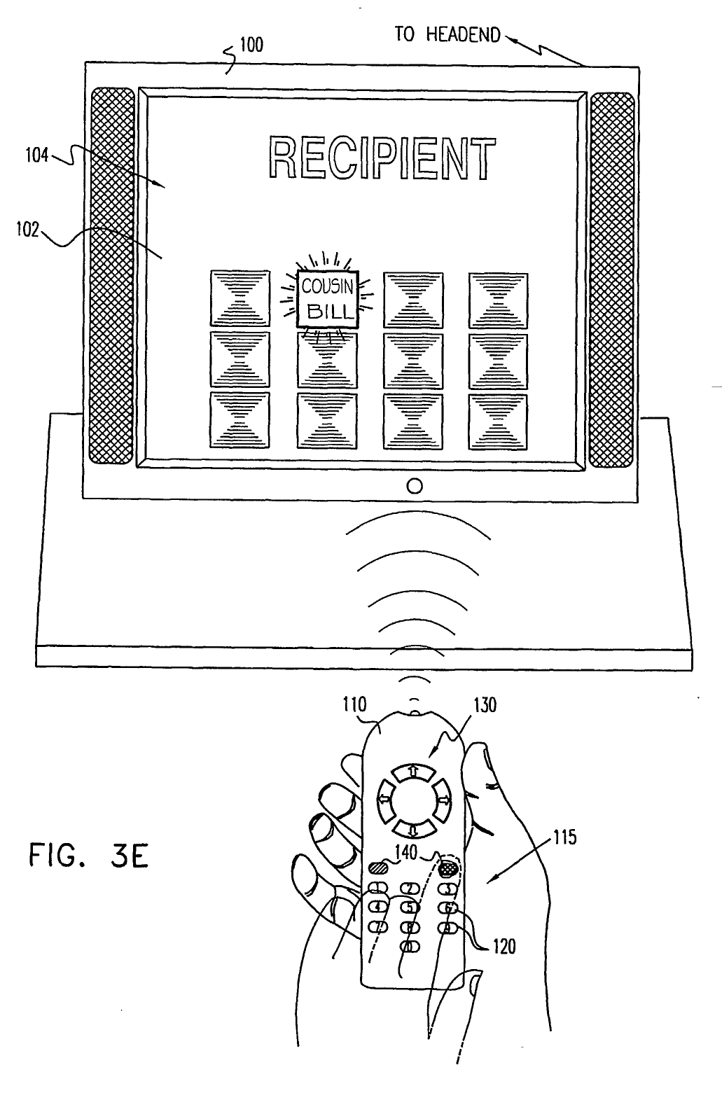

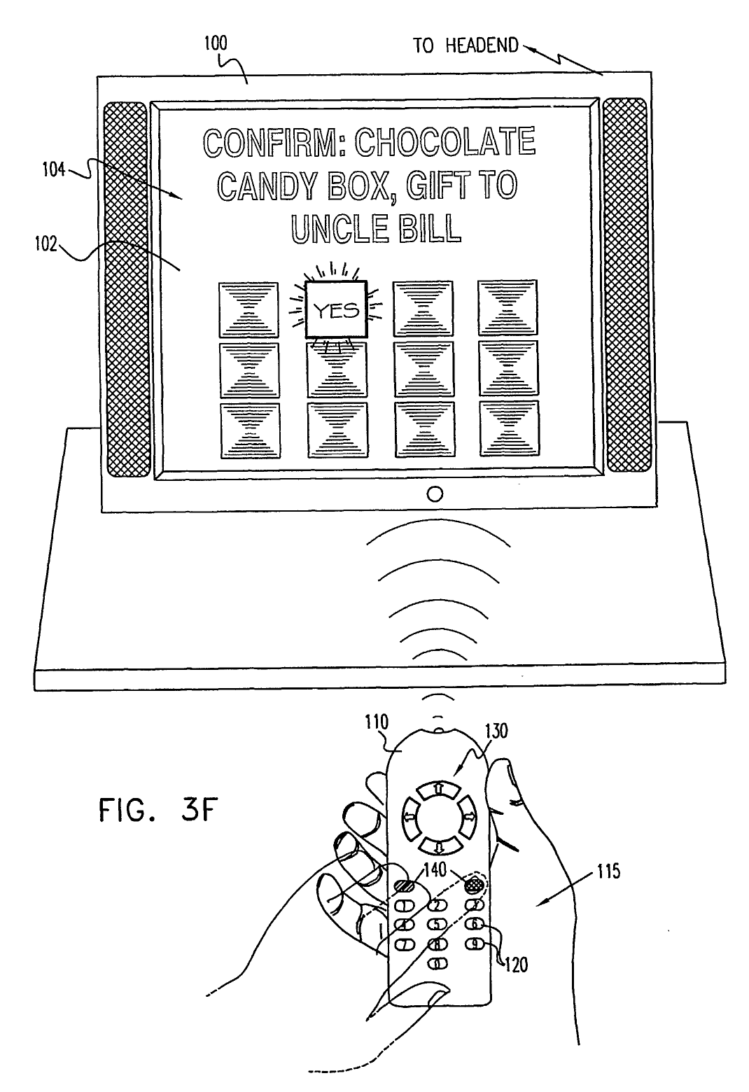

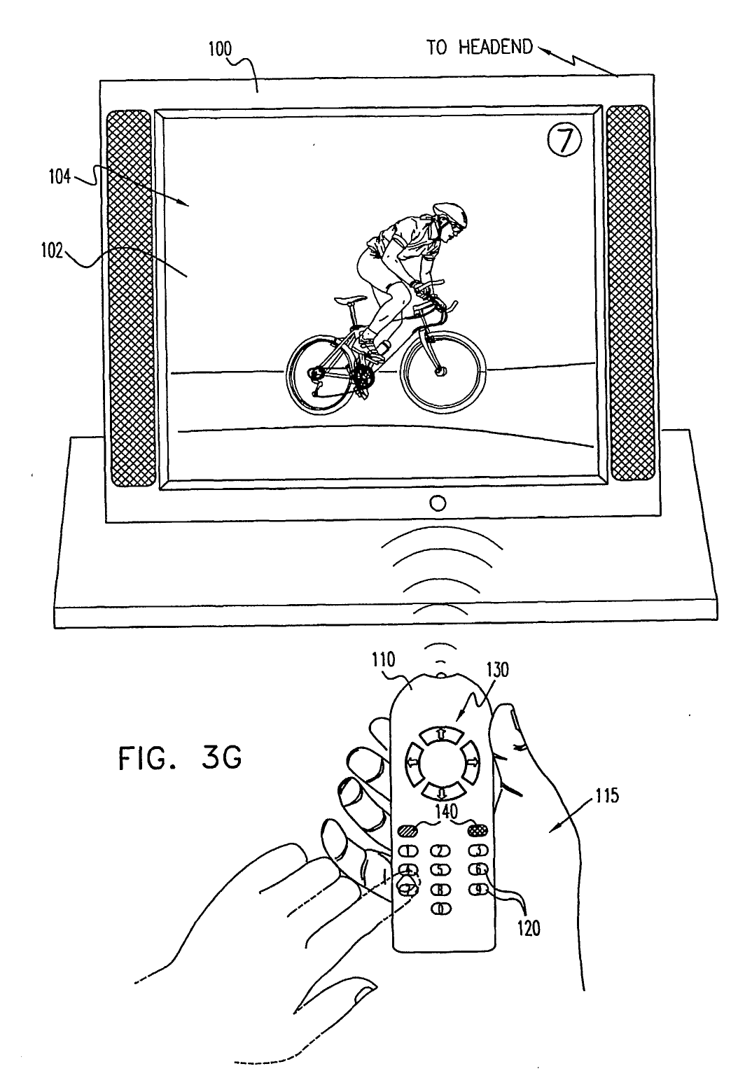

Reference is now made to FIGS. 3A-3G, which comprise a sequence of pictorial illustrations showing a system, and operation of the system, for performing a method for acquisition of goods and services and viewing television content, constructed and operative in accordance with another alternative preferred embodiment of the present invention. The preferred embodiment of FIGS. 3A-3G is similar to the preferred embodiments described above, except as described below.

The operation of the system of FIGS. 3A-3G is now briefly described. In FIGS. 3A-3G, as can be particularly appreciated from FIGS. 3A and 3G, a user employs one or more of the numerical controls 120, also termed herein “a plurality of numerically designated keys”, for television selection and not for purchasing goods and services.

While the user is viewing selected television programs, the user can initiate the purchase of goods and services by employing at least one of the at least one direction control 130 and the at least one non-numerical non-direction control 140 to select the desired goods or services. The purchase is completed by employing at least one of the at least one direction control 130 and the at least one non-numerical non-direction control 140 at least one time.

In the system illustrated by FIGS. 3A-3G the non-numerical non-direction control 140 is employed multiple times to complete the desired purchase. It is appreciated that other actuation sequences may alternatively be used. It is also appreciated that the user need not view a television program in order to purchase goods and services using the system of FIGS. 3A-3G.

It is further appreciated that although use of non-numerical non-direction control 140 is shown in FIGS. 3A-3G, direction control 130 can also be used.

Reference is now additionally made to FIG. 11, which is a simplified flowchart illustration of a preferred method of operation of the system of FIGS. 3A-3G. The method of FIG. 11 is self-explanatory with reference to the above description.

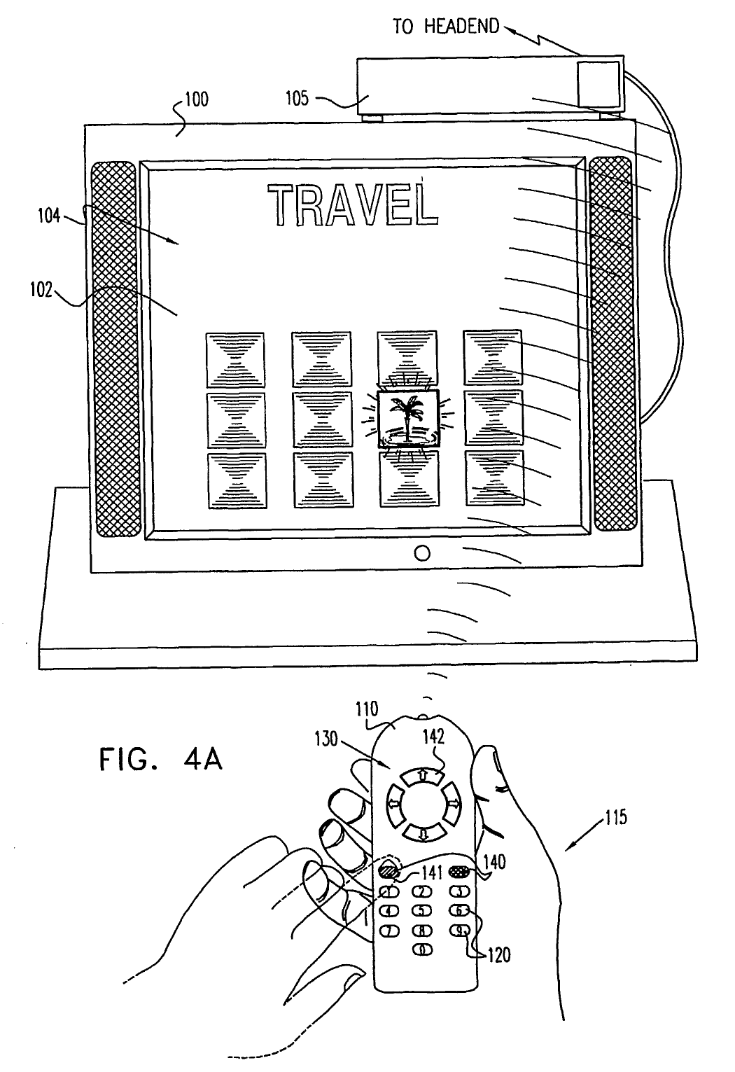

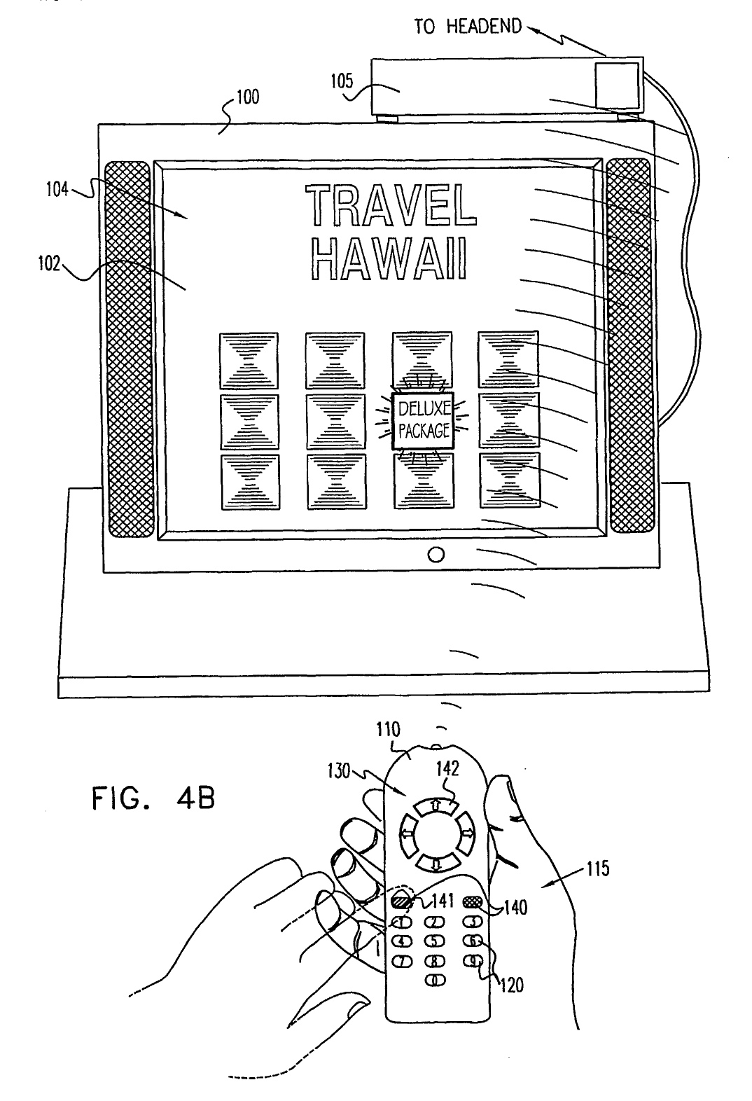

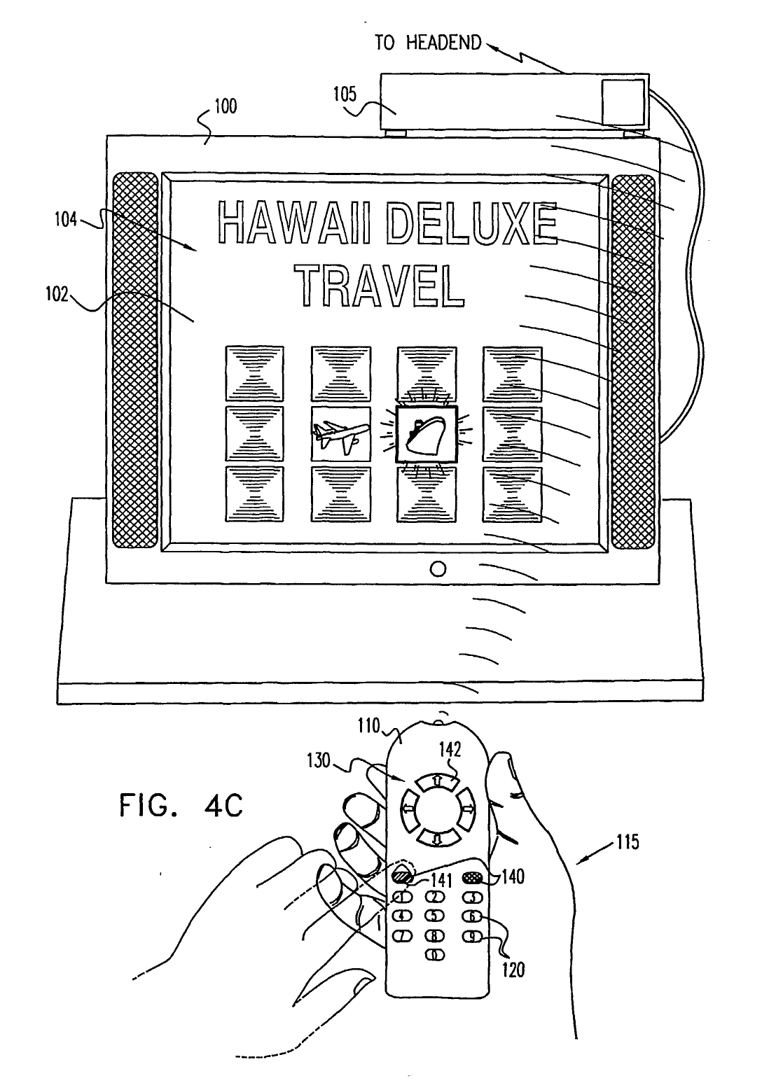

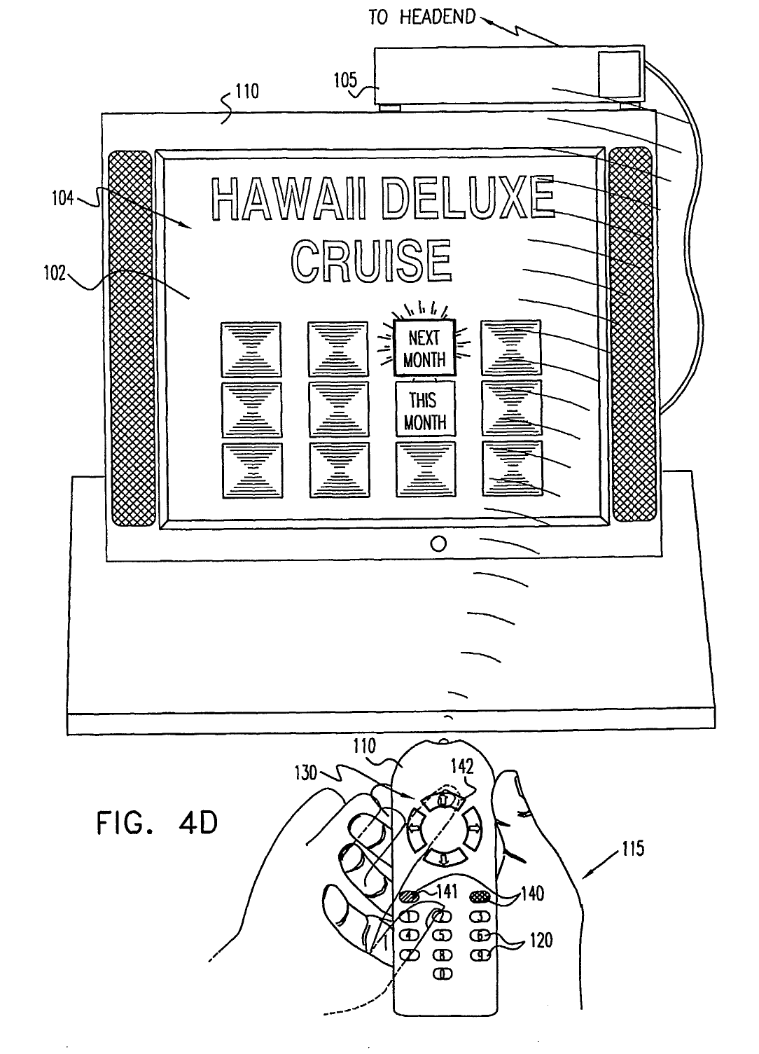

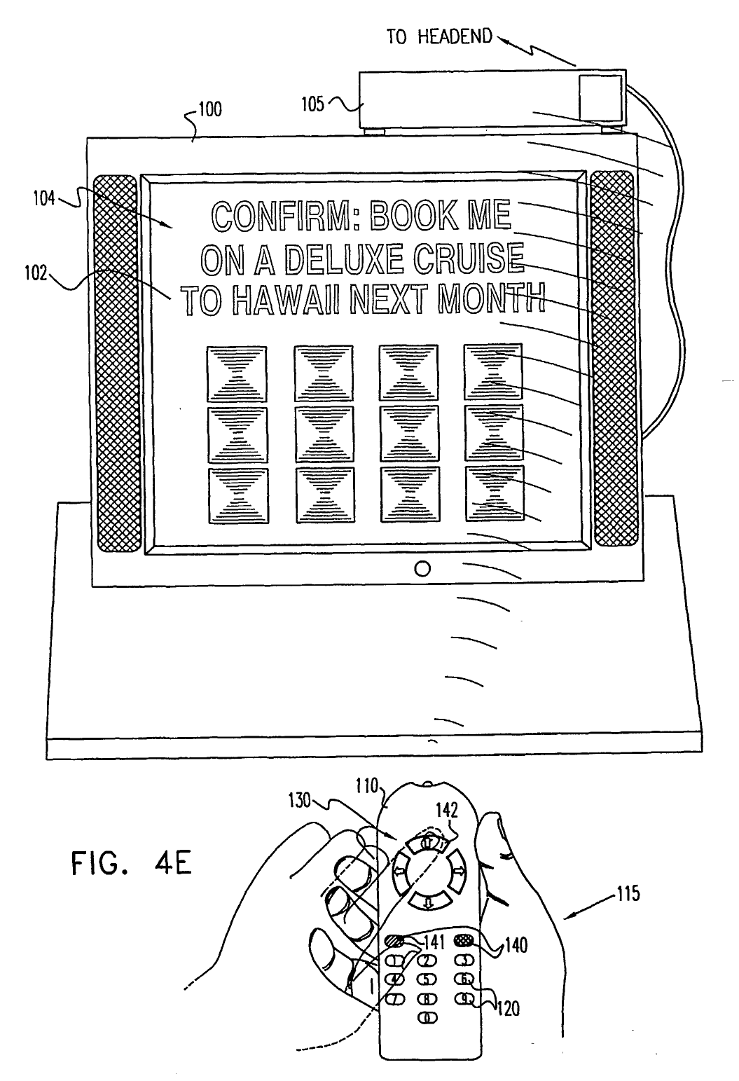

Reference is now made to FIGS. 4A-4E, which comprise a sequence of pictorial illustrations showing a system, and operation of the system, for performing a method for acquisition of goods and services, constructed and operative in accordance with still another alternative preferred embodiment of the present invention.

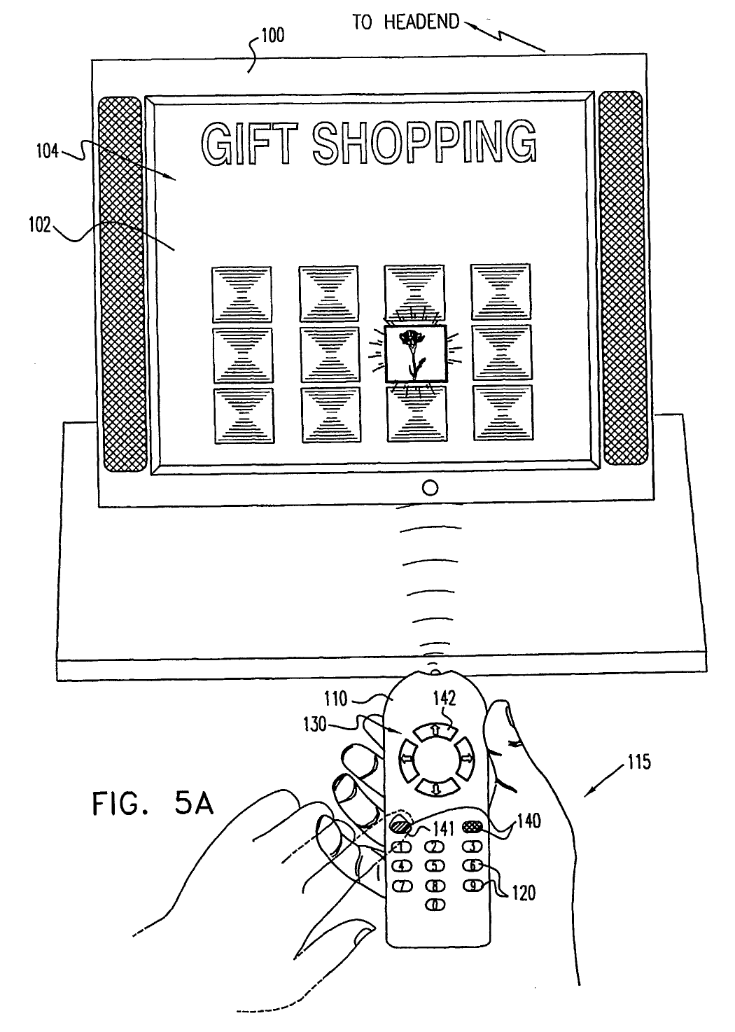

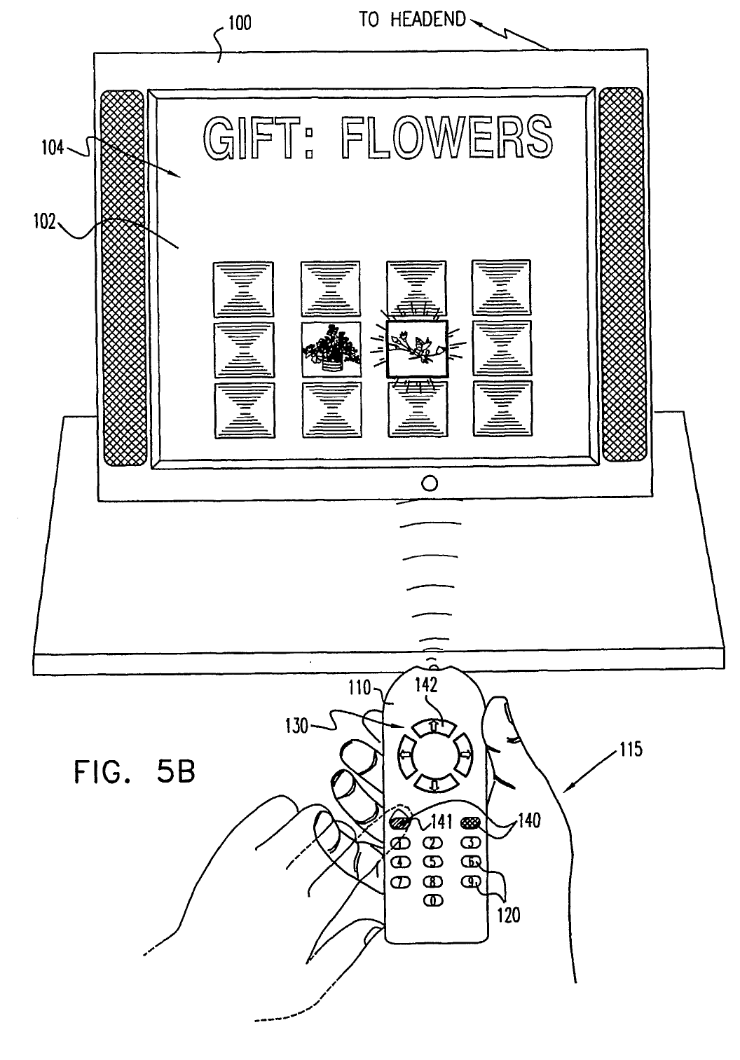

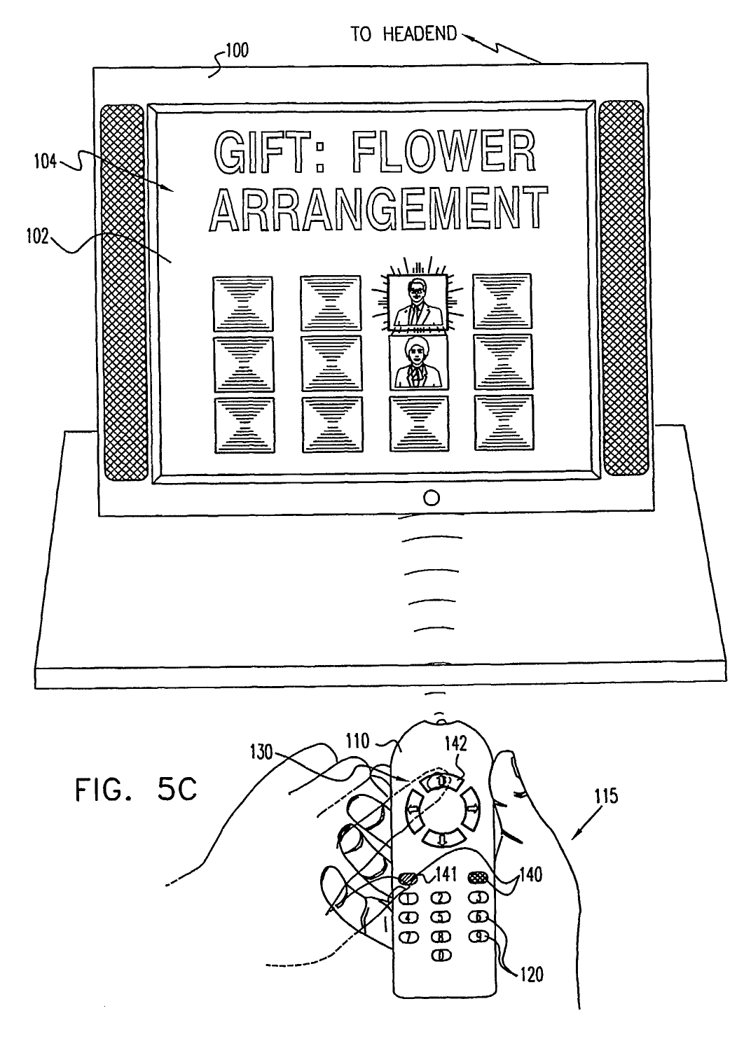

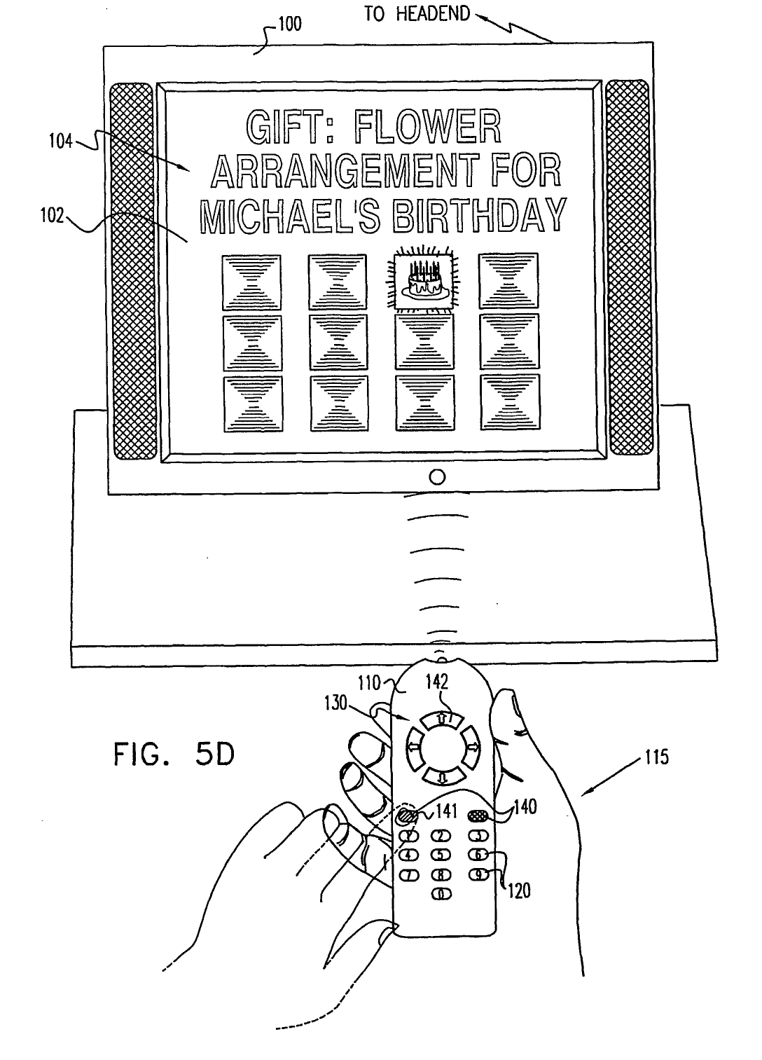

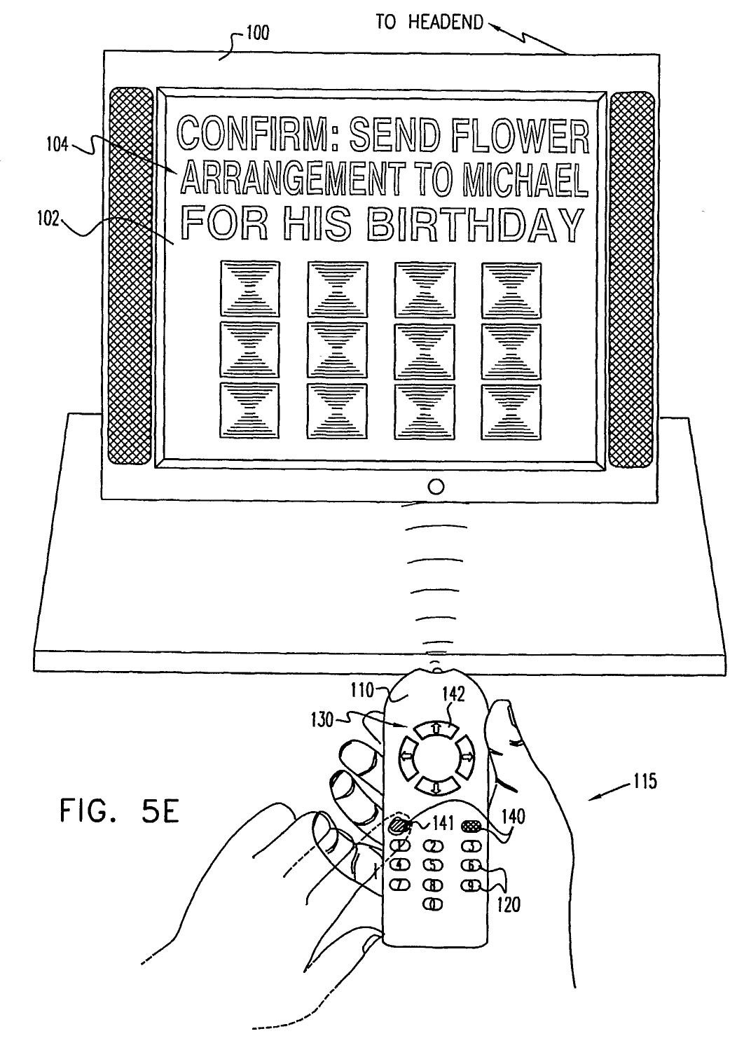

Reference is now additionally made to FIGS. 5A-5E, which comprise a sequence of pictorial illustrations showing a system, and operation of the system, for performing a method for acquisition of goods and services, constructed and operative in accordance with yet another alternative preferred embodiment of the present invention.

The embodiments of FIGS. 4A-4E and 5A-5E illustrate a principle of minimization of transitions between various ones of the plurality of controls 115 in the course of carrying out a transaction. In some preferred embodiments of the present invention, it is appreciated that minimization of such transitions makes it easy for a user of the system to carry out a transaction; therefore, minimization of such transitions may be desired by a provider of the system.

In the embodiment of FIGS. 4A-4E, by way of a first example only, a plurality of actuations of a first control 141 is followed by a single transition, between FIGS. 4C and 4D, and then by a plurality of actuations of a second control 142, thus completing a transaction.

By way of further example only, in the embodiment of FIGS. 5A-5E, a plurality of actuations of the first control 141 is followed by a first transition, between FIGS. 5B and 5C, then by a single actuation of the second control 142 in FIG. 5C, then by a second transition between FIGS. 5C and 5D, and finally by another plurality of actuations of the first control 141 in FIGS. 5D and 5E, thus completing a transaction.

It is particularly appreciated that the examples given with reference to FIGS. 4A-4E and 5A-5E are given by way of example only, that the examples are not meant to be limiting, and that many other alternatives which preserve the same principle of minimization of transitions will occur to persons skilled in the art.

Further optimizations in the design of the user interface 104, relevant particularly to the embodiments of FIGS. 4A-4E and 5A-5E, are described below with reference to FIGS. 12-15.

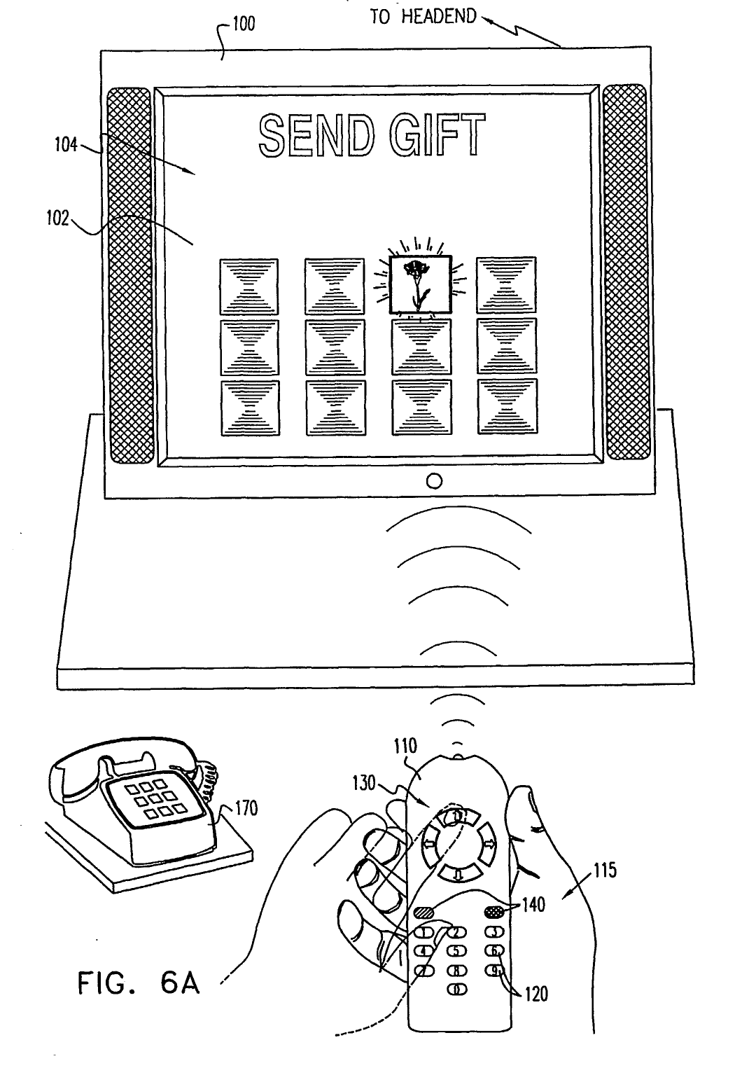

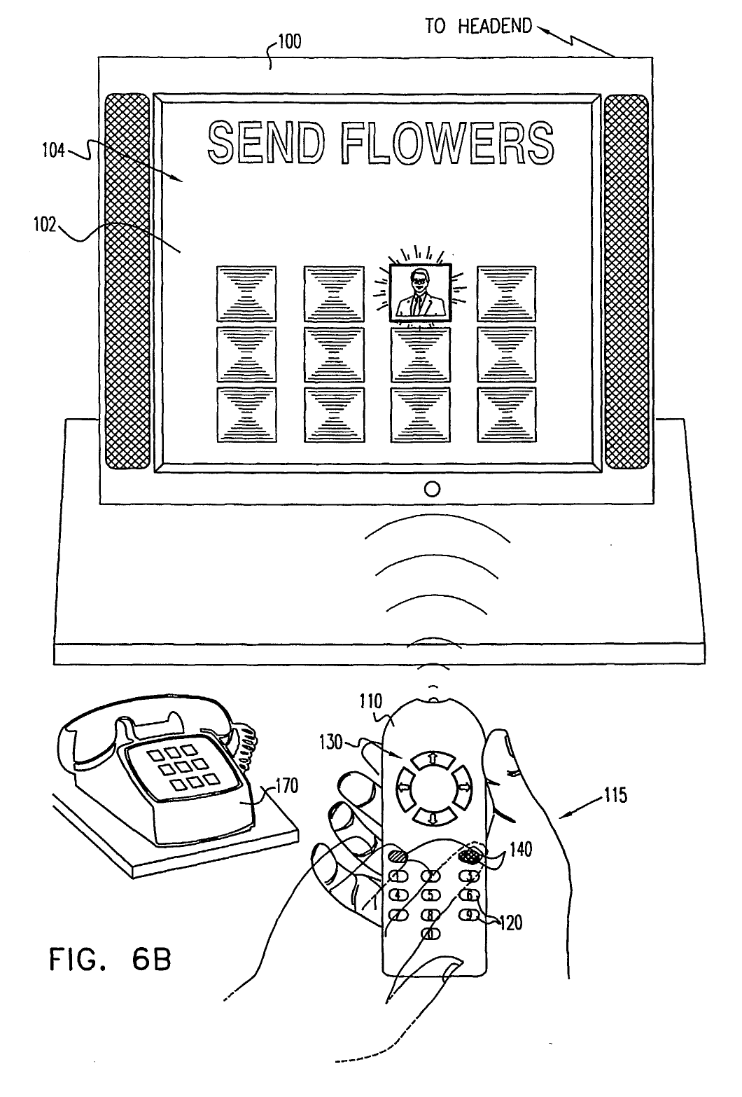

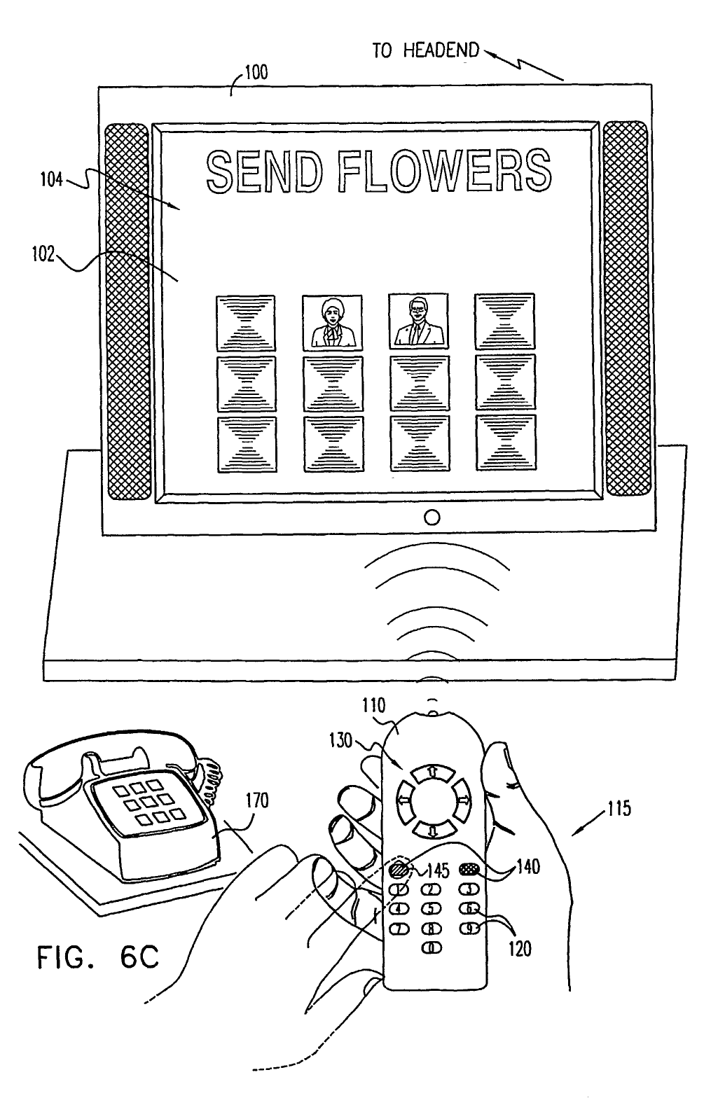

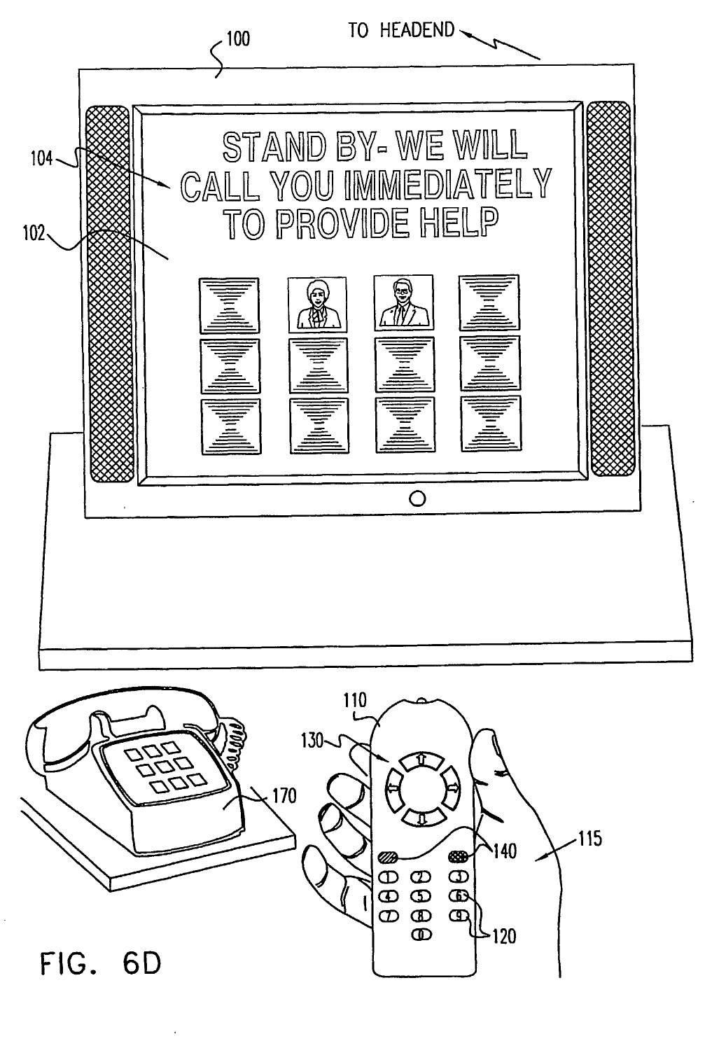

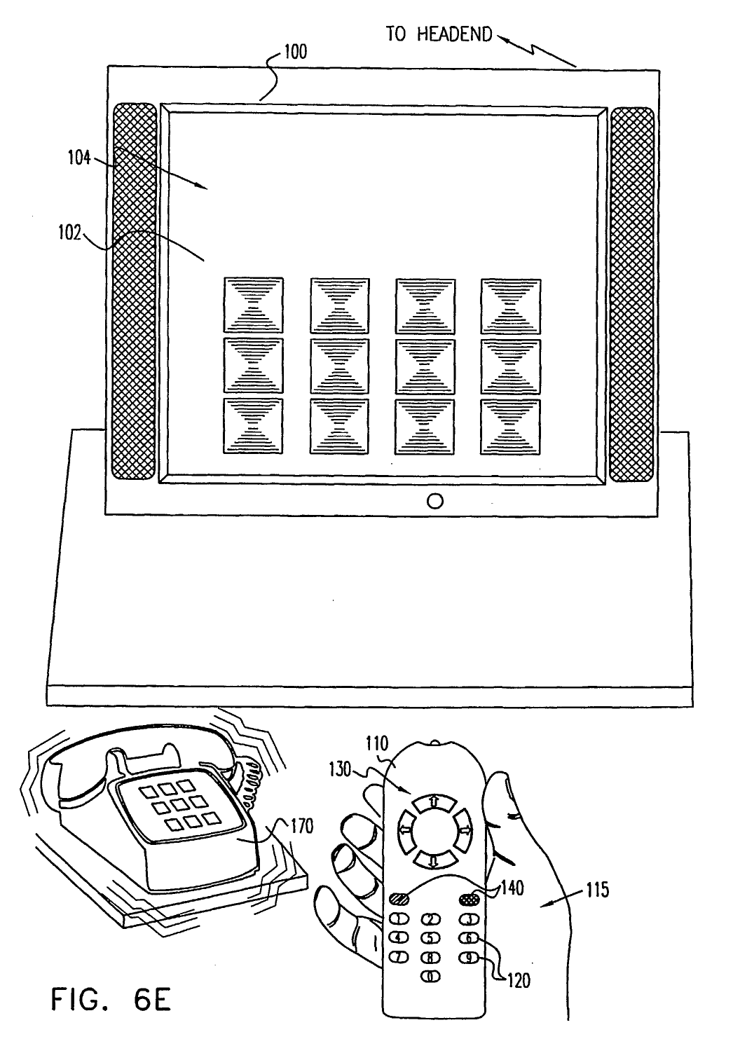

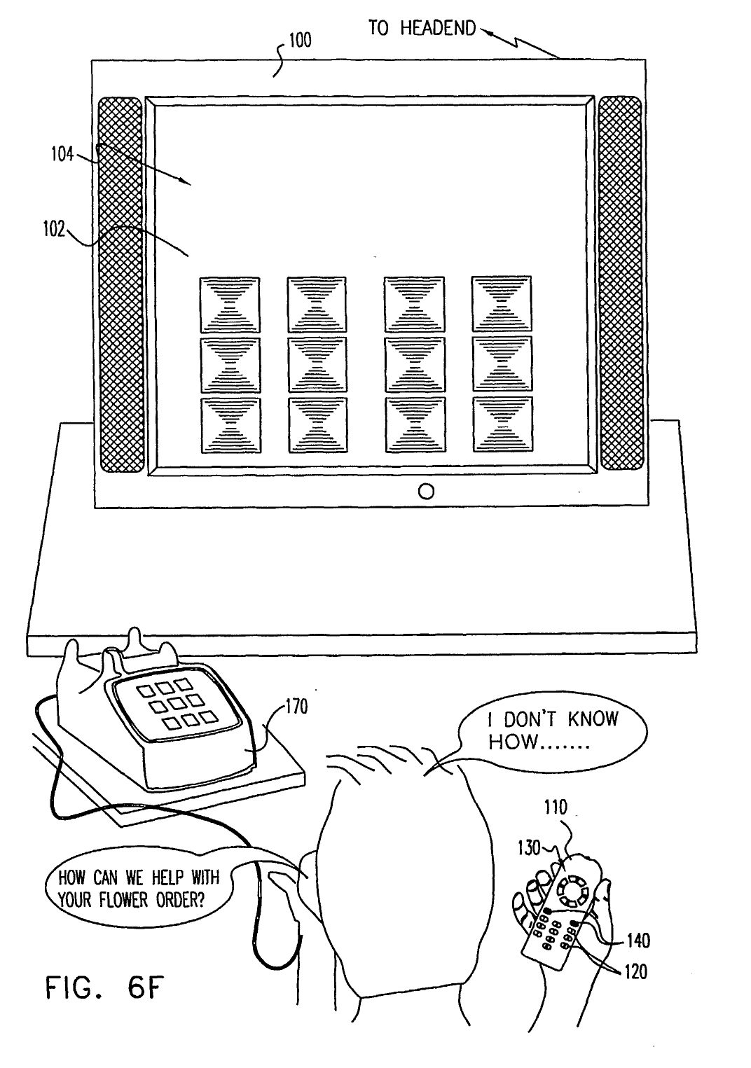

Reference is now made to FIGS. 6A-6F, which comprise a sequence of pictorial illustrations showing a system, and operation of the system, for performing a method for acquisition of goods and services, constructed and operative in accordance with a still further alternative preferred embodiment of the present invention.

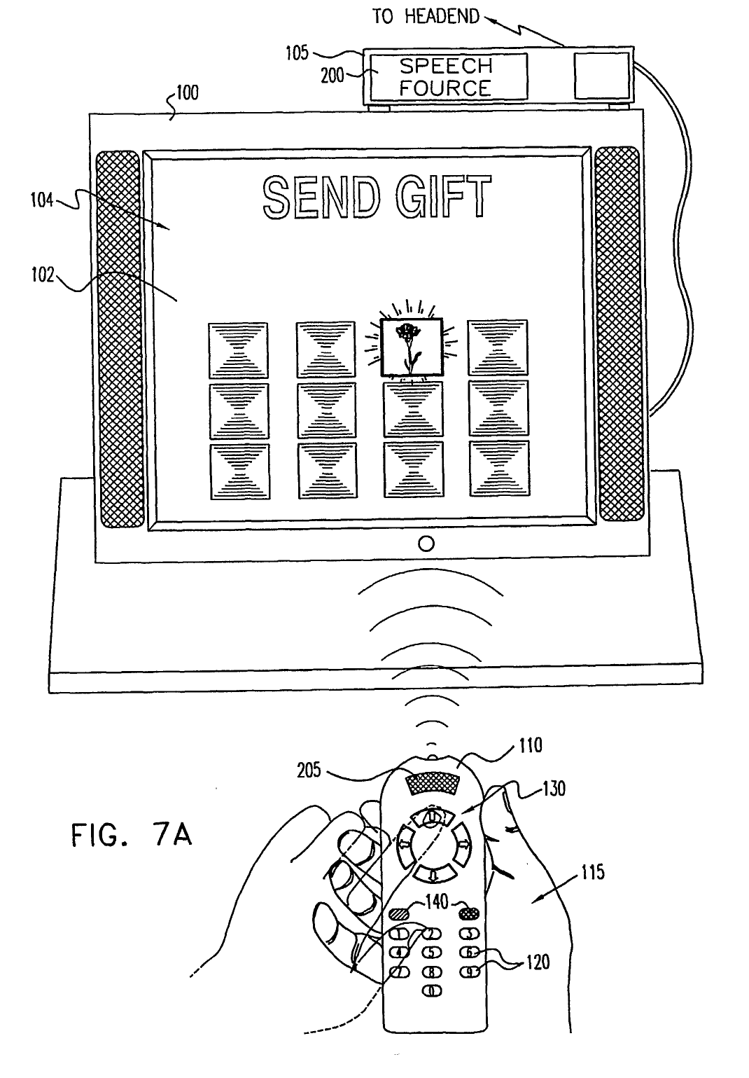

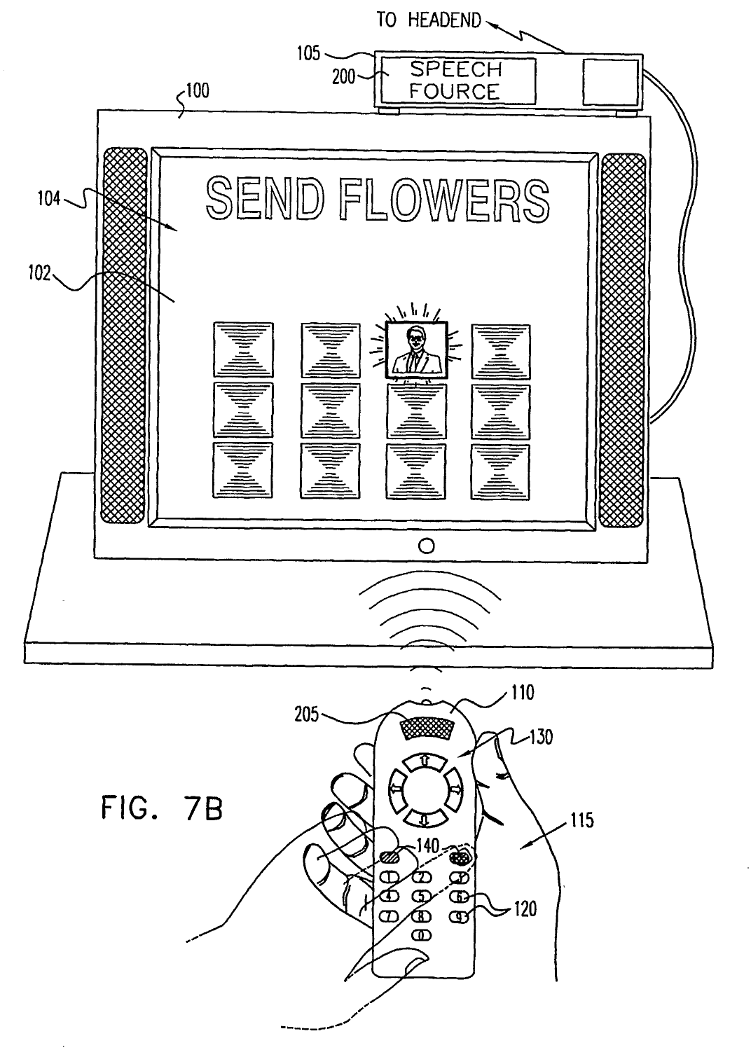

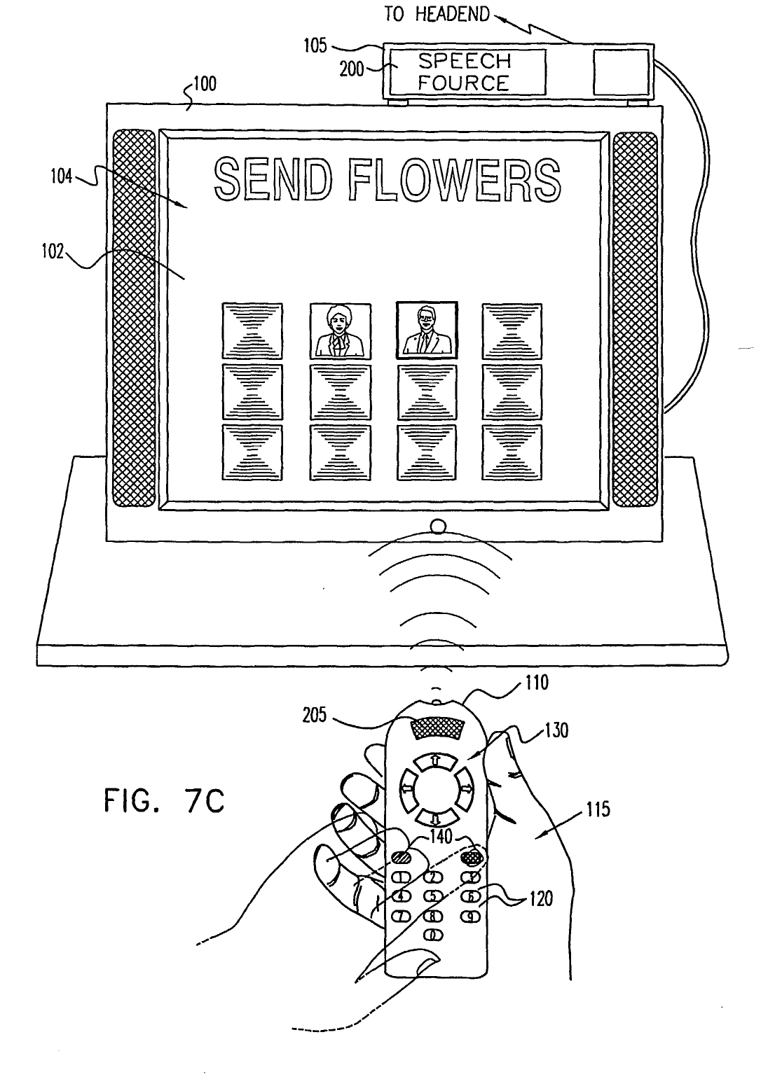

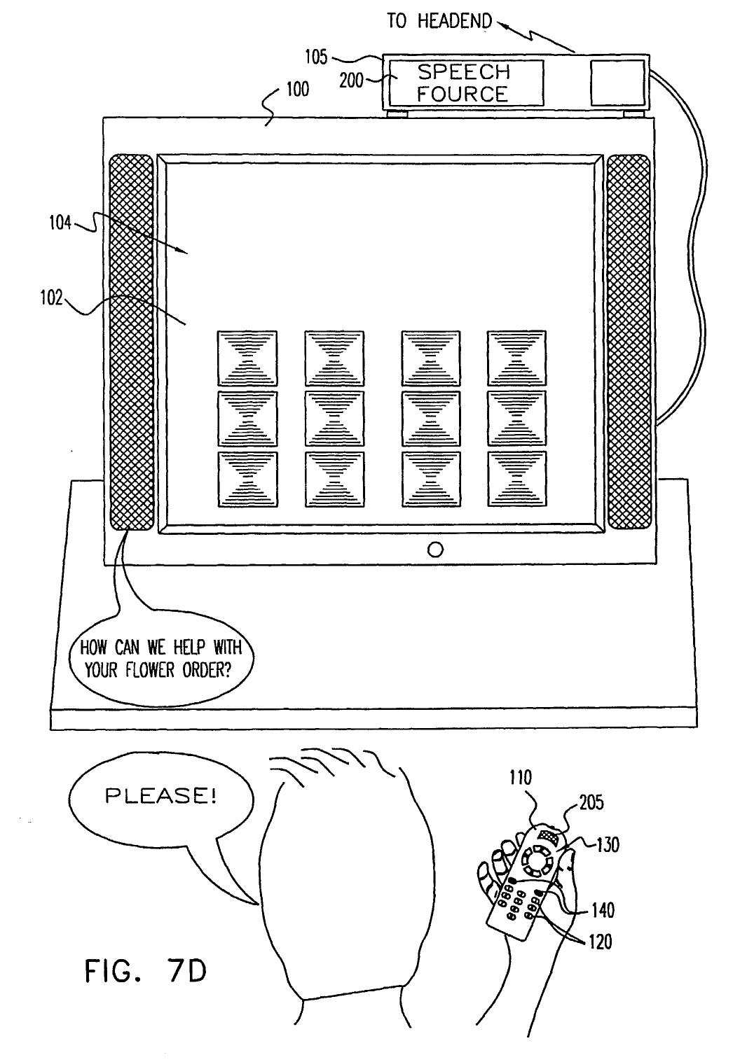

Reference is now additionally made to FIGS. 7A-7D, which comprise a sequence of pictorial illustrations showing a system, and operation of the system, for performing a method for acquisition of goods and services, constructed and operative in accordance with another alternative preferred embodiment of the present invention.

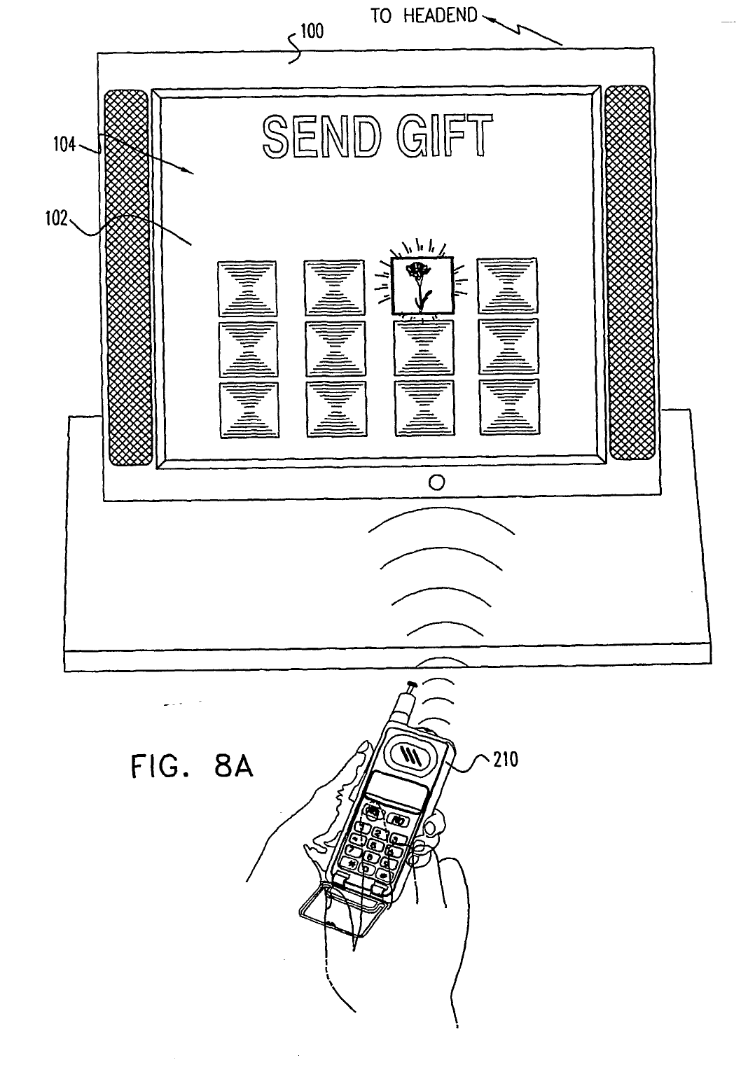

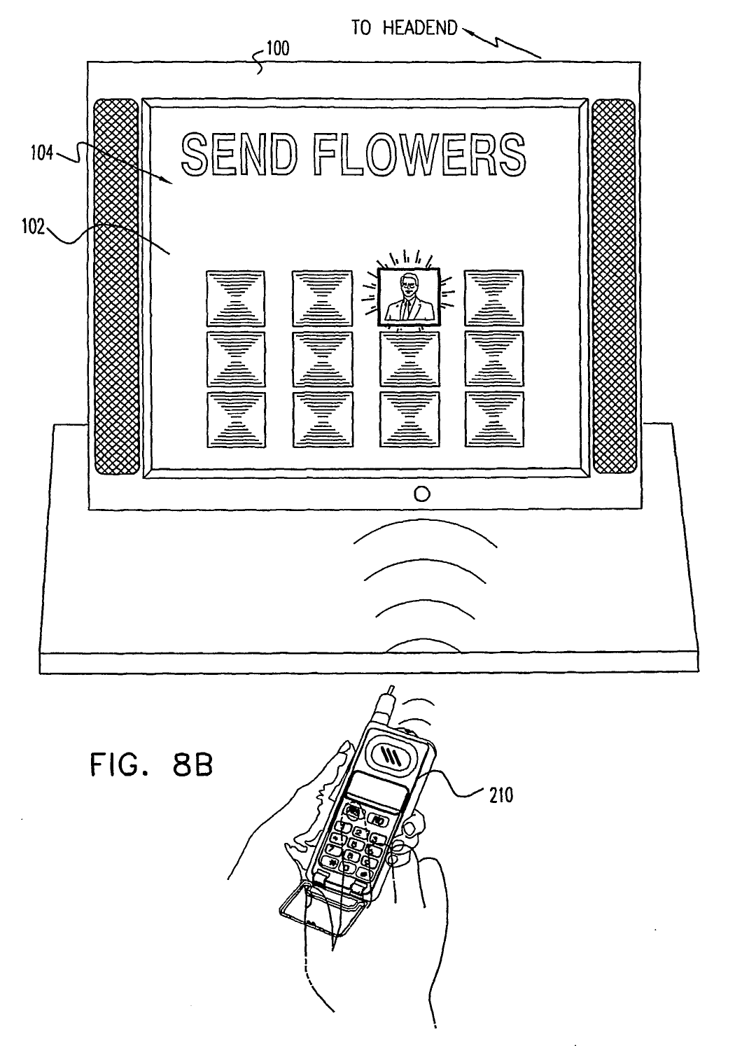

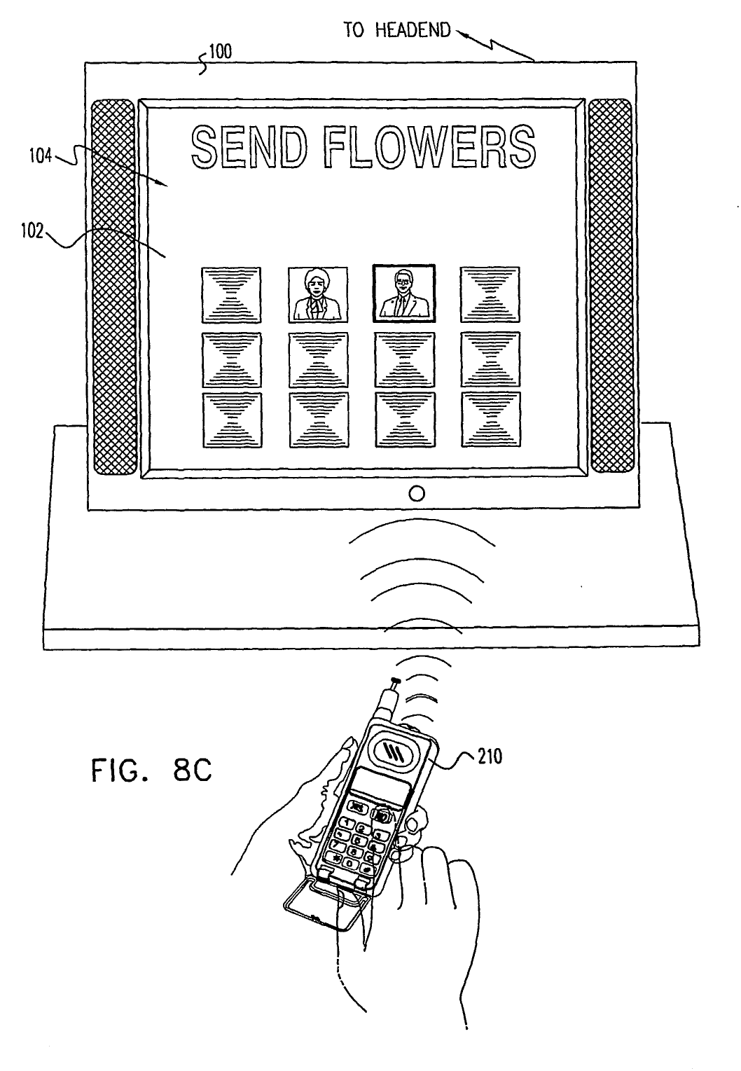

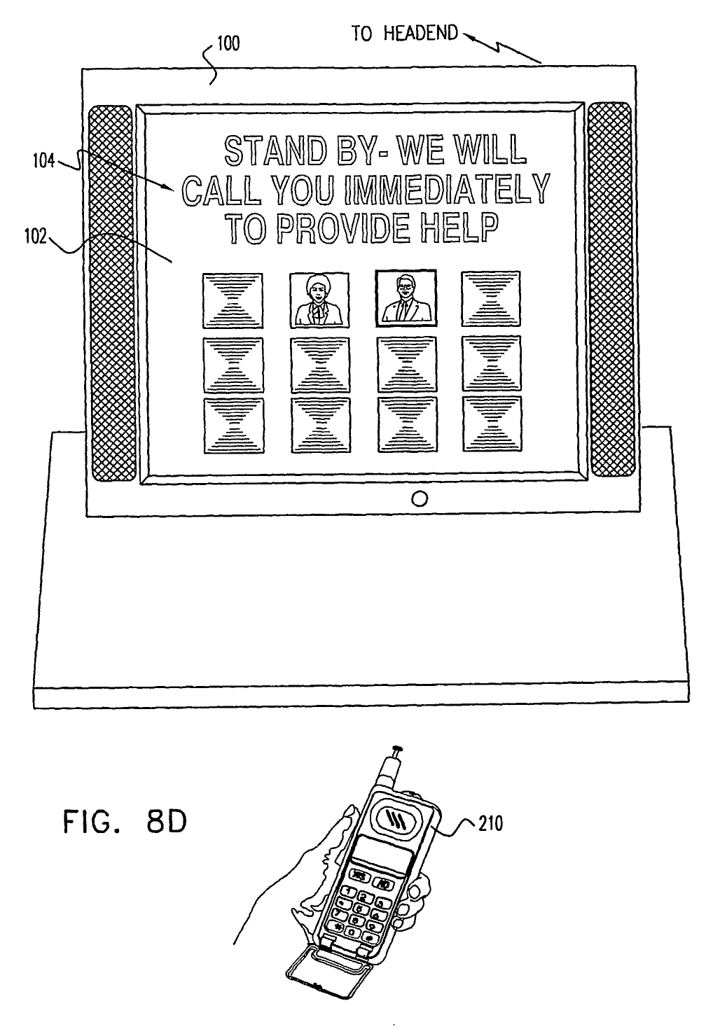

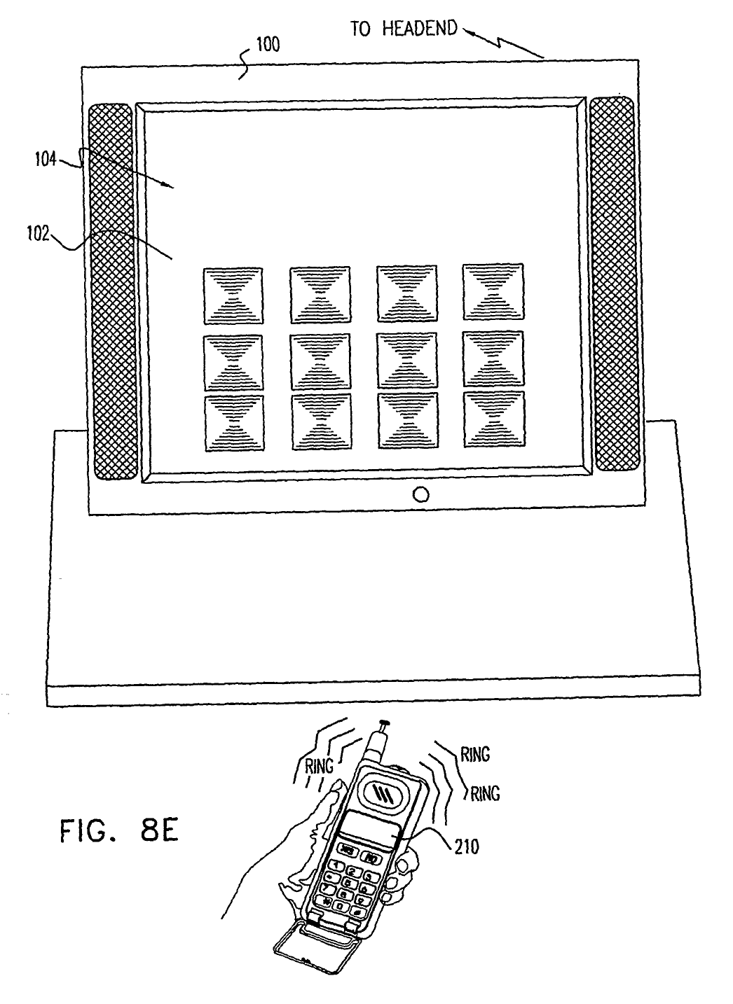

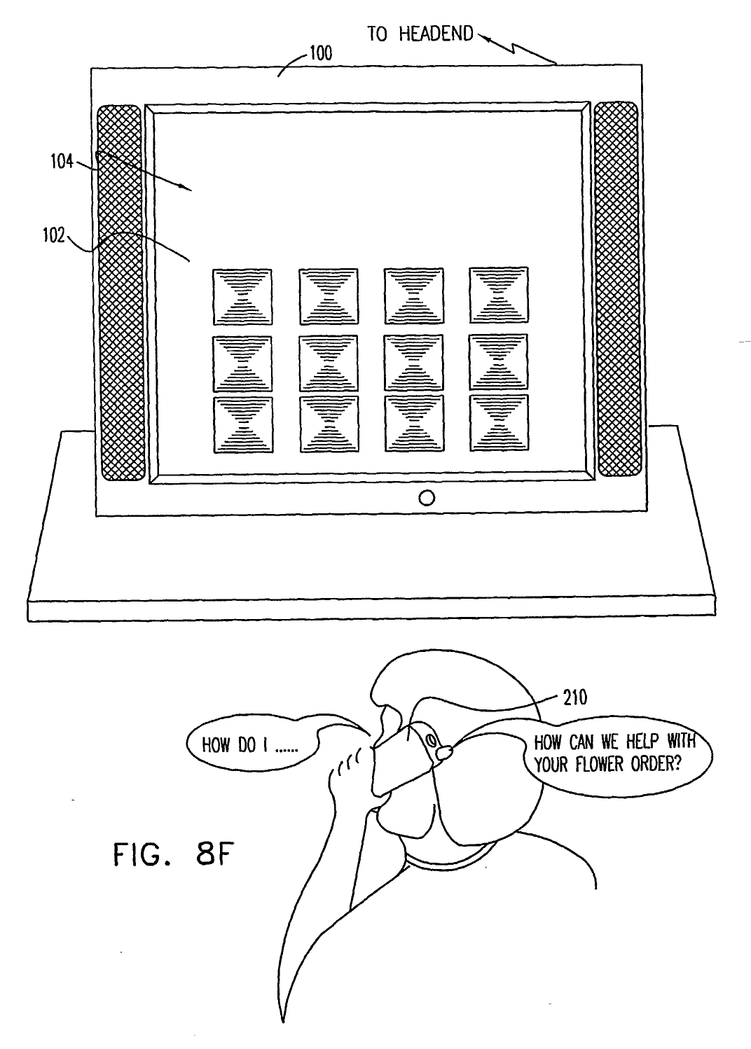

Reference is now additionally made to FIGS. 8A-8F, which comprise a sequence of pictorial illustrations showing a system, and operation of the system, for performing a method for acquisition of goods and services, constructed and operative in accordance with a still further alternative preferred embodiment of the present invention.

In the embodiments of FIGS. 6A-6F, 7A-7D, and 8A-8F, a transaction for selected goods or services is completed, at least partially, by a user or customer speaking. As is well known in the art, the customer may employ a telephone 170 or any other appropriate telephonic communication apparatus. Interactive voice communication can be between the user and a human or between the user and a synthesized voice source. Interactive voice communication can be initiated other than by a user dialing a telephone call, by an operator dialing a telephone call, other than by an operator dialing a telephone call to the user, or by an automatic call back system in response to a user command.

It is appreciated that user speech may provide transaction information other than information related to selection of said goods or services such as, for example, transaction information related to a delivery address. Transaction information received as a result of the user speaking may or may not be stored. Some of the transaction information received may be stored, using any appropriate means as is well known in the art, as a result of the user speaking on the television. The user may also be asked to confirm the correctness of the information received.

In the embodiment of FIGS. 6A-6F, when a user indicates, typically but not necessarily by pressing on a help control 145 (FIG. 6C), the return path mentioned above is used to send a message to an appropriate center (not shown), such as a broadcast center or an order fulfillment center, indicating that help is needed. Preferably, the message includes identifying information identifying the customer and the transaction in progress, so that help provided may be provided with appropriate knowledge: of a customer's identity; of the customer's consumer profile; of the customer's past transactions; of the customer's preferences including but not limited to shipping and billing preferences; and of the transaction in progress.

In this regard, it is appreciated that it is preferable for a broadcast center or an order fulfillment center serving multiple vendors to be used, so that customer profile information and related information may be available in one place, such as in a single customer database.

In the embodiment of FIGS. 6A-6F, a telephone call is placed from the center back to the customer, and the order is completed, at least partially, by the customer speaking.

In the embodiment of FIGS. 7A-7D, a speech source 200 is comprised in the STB 105, so that voice interaction may occur, using appropriate speech recognition and speech synthesis techniques as are well known in the art, via the television 100. In this case, the remote control 110 may be advantageously equipped with an appropriate microphone 205. In one preferred embodiment, the speech source 200 may be operative to pass through live voice communications from a center, as described above with reference to FIGS. 6A-6F. The speech source 200 may be incorporated in a set top box or may be incorporated in the television. In another preferred embodiment, the STB 105 may also comprise an artificial intelligence module (not shown) for providing local help based on user speech.

In the embodiment of FIGS. 8A-8F, a combined remote control/telephone 210 is used. It will be appreciated that the telephone functionality of the remote control/telephone 210 may include, for example, any one or more of: portable telephone functionality; cellular telephone technology; and other appropriate telephone technology. From the standpoint of ease of use, since the combined remote control/telephone 210 comprises a single hand-held device, the embodiment of FIGS. 8A-8F may be preferred to the embodiment of FIGS. 6A-6F.

In the embodiments of FIGS. 6A-6F, 7A-7D, and 8A-8F the user speaking may be for the purpose of selecting goods or services or may be other than for the purpose of selecting goods or services, such as for example, for giving information related to a delivery address.

Reference is now additionally made to FIG. 16, which is a simplified flowchart illustration of a preferred method of operation of the systems of FIGS. 6A-6F, 7A-7D, and 8A-8F. The method of FIG. 16 is self-explanatory with reference to the above discussion.

It is appreciated that a provider of the user interface 104 in the various embodiments of the present invention as described herein may choose to optimize the design of the user interface 104, so that selections which are favored by the provider are easier for the user to choose in effecting a purchase or a transaction. For example, selections which are easier for the user to choose may be selections which are of economic benefit to the provider or which are of expected statistical preference of the user.

The following are examples of such optimizations. Some of the examples have been described above. The examples are not meant to be limiting:

1. Using only a single control to effect a purchase.

2. Minimizing a number of transitions between controls at the expense of non-minimization of a number of engagements of controls. Reference is now made to FIG. 12, which is a simplified flowchart illustration of a preferred method of operation of the systems of FIGS. 4A-4E and 5A-5E. FIG. 12 is self explanatory.

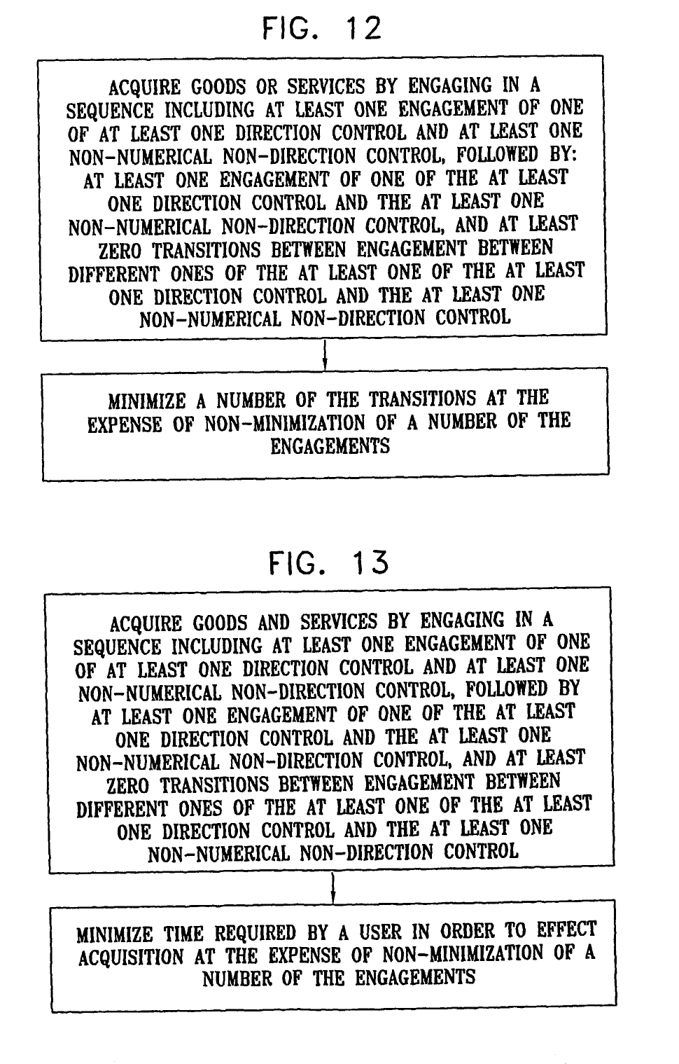

3. Minimizing time required by a user in order to effect acquisition at the expense of non-mininization of engagements of controls, it being appreciated that time minimization may be achievable together with minimization of a number of transitions, as discussed above. Reference is now made to FIG. 13, which is a simplified flowchart illustration of an alternative preferred method of operation of the systems of FIGS. 4A-4E and 5A-5E. FIG. 13 is self-explanatory.

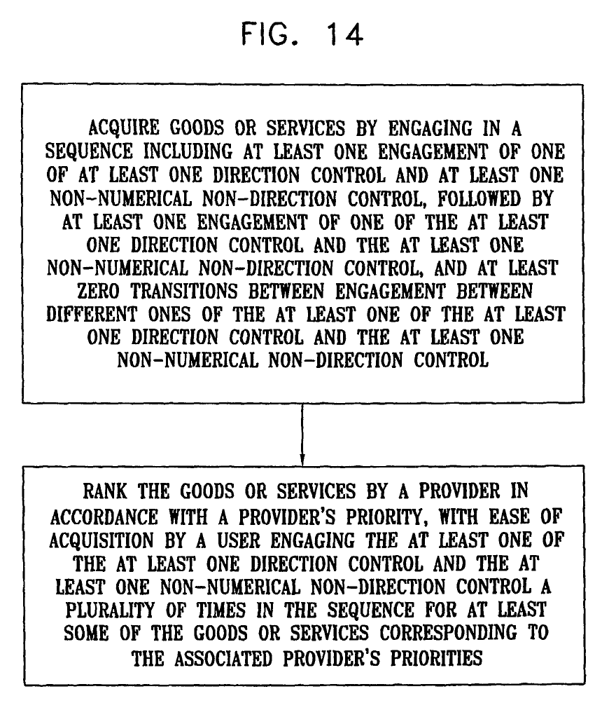

4. Ranking goods or services by a provider in accordance with a provider's priority, with ease of acquisition for at least some available goods or services corresponding to the associated provider's priorities. Reference is now made to FIG. 14, which is a simplified flowchart illustration of another alternative preferred method of operation of the systems of FIGS. 4A-4E and 5A-5E. FIG. 14 is self-explanatory.

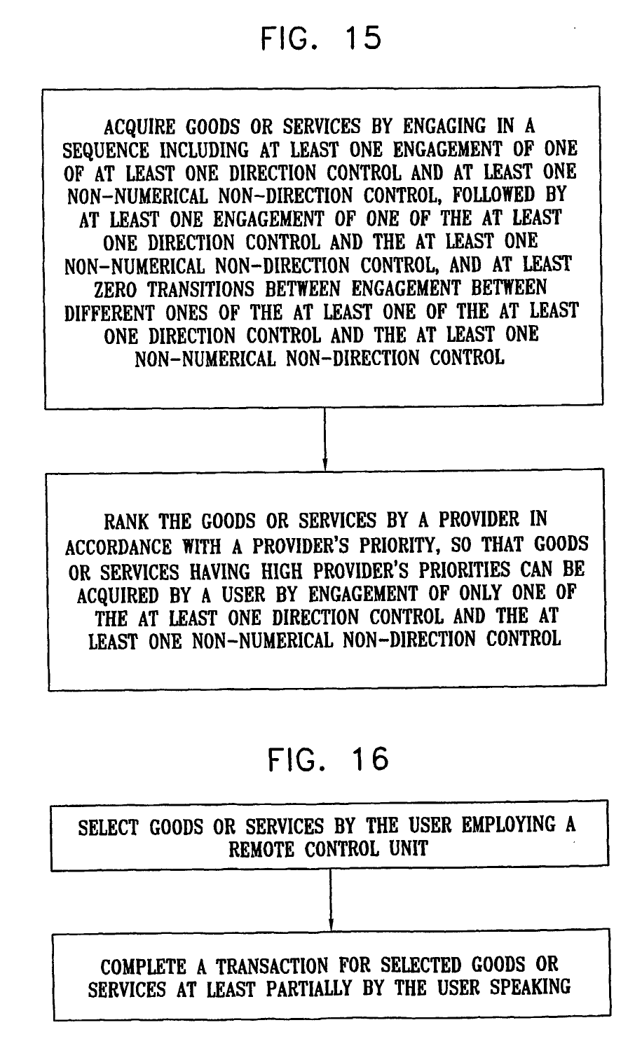

5. Ranking goods or services by a provider in accordance with a provider's priority, so that goods and services having high provider's priorities can be acquired by a user by a minimum of controls. Reference is now made to FIG. 15, which is a simplified flowchart illustration of still another preferred method of operation of the systems of FIGS. 4A-4E and 5A-5E. FIG. 15 is self-explanatory.

6. Completing a transaction at least partially by a user speaking, as described above with reference to FIGS. 6A-6F, 7A-7D, 8A-8F, and 16.

7. Minimizing the number of engagements of controls used.

From the above points 1-7, persons skilled in the art will appreciate, in light of the other features of the present invention as described herein, how to design a user interface 104, incorporating one or more of the indicated optimizations.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

It will be appreciated by persons skilled in the art that the present invention is not limited by what has been particularly shown and described hereinabove. Rather the scope of the invention is defmed only by the claims which follow:

What is claimed is:

1. In an environment comprising a television and a remote control unit hand held by a user and including at least one direction control, a method for acquisition of goods or services comprising:
selecting goods or services by employing only said at least one direction control; and
completing a transaction for selected goods or services by employing only said at least one direction control.

2. In an environment comprising a television and a remote control unit hand held by a user and including at least one non-numerical non-direction control, a method for acquisition of goods or services comprising:
selecting goods or services by employing only said at least one non-numerical non-direction control; and
completing a transaction for selected goods or services by employing only said at least non-numerical non-direction control.

3. In an environment comprising a television and a remote control unit hand held by a user and including at least one numerical control, a method for acquisition of goods or services comprising:
selecting goods or services by employing only said at least one numerical control; and
completing a transaction for selected goods or services by employing only said at least one numerical control.

4. In an environment comprising a television and a remote control unit hand held by a user and including at least one direction control and at least one non-direction control, a method for acquisition of goods or services comprising:
selecting goods or services by employing only at least one of said at least one direction control and said at least one non-direction control; and
completing a transaction for selected goods or services by employing only at least one of said at least one direction control and said at least one non-direction control.

5. A method according to claim 4 and wherein said transaction is a non-purchase transaction.

6. A method according to claim 4 and wherein said non-direction control is a select control.

7. In an environment comprising a television and a remote control unit hand held by a user and including at least one direction control, at least one non-numerical non-direction control and a plurality of numerical designated keys, a method for acquisition of goods or services and viewing television content comprising:
acquiring goods or services by employing at least one of said at least one direction control and said at least one non-numerical non-direction control; and
employing said plurality of numerical designated keys for television selection and not for purchase of goods or services.

8. A method according to claim 7 and wherein said acquiring is a purchase transaction.

9. A method according to claim 7 and wherein said acquiring is a non-purchase transaction.

10. In an environment comprising a television and a remote control unit hand held by a user and including at least one direction control and at least one non-numerical non-direction control, a method for acquisition of goods or services comprising acquiring goods or services by providing a user interface for a user engaging at least one of said at least one direction control and said at least one non-numerical non-direction control a plurality of times in a sequence including at least:
A. at least one engagement of one of said at least one direction control and said at least one non-numerical non-direction control, followed by
B. at least one engagement of one of said at least one direction control and said at least one non-numerical non-direction control, and
C. at least zero transitions between engagement between different ones of said at least one of said at least one direction control and said at least one non-numerical non-direction control, said user interface being characterized in that:
a number of said transitions is minimized at the expense of non-minimization of a number of said engagements.

11. In an environment comprising a television and a remote control unit hand held by a user and including at least one direction control and at least one non-numerical non-direction control, a method for acquisition of goods or services and viewing television content comprising acquiring goods or services by providing a user interface for a user engaging at least one of said at least one direction control and said at least one non-numerical non-direction control a plurality of times in a sequence including at least:
A. at least one engagement of one of said at least one direction control and said at least one non-numerical non-direction control, followed by
B. at least one engagement of one of said at least one direction control and said at least one non-numerical non-direction control, and
C. at least zero transitions between engagement between different ones of said at least one of said at least one direction control and said at least one non-numerical non-direction control, said user interface being characterized in that:
time required by a user in order to effect acquisition is minimized at the expense of non-minimization of a number of said engagements.

12. In an environment comprising a television and a remote control unit hand held by a user and including at least one direction control and at least one non-numerical non-direction control, a method for acquisition of goods or services and viewing television content comprising acquiring goods or services by providing a user interface for a user engaging at least one of said at least one direction control and said at least one non-numerical non-direction control a plurality of times in a sequence including at least:
A. at least one engagement of one of said at least one direction control and said at least one non-numerical non-direction control, followed by
B. at least one engagement of one of said at least one direction control and said at least one non-numerical non-direction control, and
C. at least zero transitions between engagement between different ones of said at least one of said at least one direction control and said at least one non-numerical non-direction control, said user interface being characterized in that:
said goods or services are ranked by a provider in accordance with a provider's priority; and
ease of acquisition by a user engaging said at least one of said at least one direction control and said at least one non-numerical non-direction control a plurality of times in said sequence for at least some of said goods or services corresponds to the provider's priorities associated therewith.

13. A method according to claim 12 and wherein said user interface is configured such that goods or services having high provider's priorities can be acquired by a user without engaging said at least one direction control.

14. A method according to claim 12 or claim 13 and wherein said user interface is configured such that goods or services having high provider's priorities can be acquired by a user with minimized engagement of said at least one direction control.

15. In an environment comprising a television and a remote control unit hand held by a user and including at least one direction control and at least one non-numerical non-direction control, a method for acquisition of goods or services and viewing television content comprising acquiring goods or services by providing a user interface for a user engaging at least one of said at least one direction control and said at least one non-numerical non-direction control a plurality of times in a sequence including at least:
A. at least one engagement of one of said at least one direction control and said at least one non-numerical non-direction control, followed by
B. at least one engagement of one of said at least one direction control and said at least one non-numerical non-direction control, and
C. at least zero transitions between engagement between different ones of said at least one of said at least one direction control and said at least one non-numerical non-direction control, said user interface being characterized in that:
said goods or services are ranked by a provider in accordance with a provider's priority; and
goods or services having high provider's priorities can be acquired by a user by engagement of only one of said at least one direction control and said at least one non-numerical non-direction control.

16. In an environment comprising a television and a remote control unit hand held by a user, a method for acquisition of goods or services comprising:
selecting goods or services by the user employing said remote control unit; and
completing a transaction for selected goods or services at least partially by the user speaking.

17. A method for acquisition of goods and services according to claim 16 and wherein said completing includes the user engaging in interactive voice communication with a synthesized speech source.

18. A method according to claim 16 or claim 17 and wherein said synthesized speech source is incorporated in a set top box.

19. A method according to any of claims 16-18 and wherein said synthesized speech source is incorporated in said television.

20. A method according to any of claims 16-19 and wherein said completing includes the user engaging in interactive voice communication with a human via a telephone.

21. A method according to any of claims 16-20 and wherein said interactive voice communication is initiated other than by said user dialing a telephone call.

22. A method according to any of claims 16-21 and wherein said interactive voice communication is initiated by an operator dialing a telephone call to the user.

23. A method according to any of claims 16-21 and wherein said interactive voice communication is initiated other than by an operator dialing a telephone call to the user.

24. A method according to any of claims 16-23 and wherein said interactive voice communication is initiated by an automatic call back system in response to a user command.

25. A method according to any of claims 16-24 and wherein said user speaking provides transaction information other than selection of said goods or services.

26. A method according to any of claims 16-25 and wherein said user speaking provides transaction information related to a delivery address.

27. A method according to any of claims 16-26 and also comprising the step of storing transaction information received as a result of the user speaking.

28. A method according to any of claims 16-27 and also comprising displaying at least some of the transaction information received, as a result of the user speaking, on said television.

29. A method according to any of claims 16-28 and also comprising obtaining user confirmation of the correctness of the transaction information received, as a result of the user speaking, on said television following display thereof on said television.

30. A method according to any of claims 1-4 and wherein said transaction is a purchase transaction.

31. A method according to any of claims 1-4 and wherein said transaction is a non-purchase transaction.

32. A method according to any of claims 1-4 and 7-31 and wherein said services include at least one of gambling services, betting services, gaming services, financial services, educational services, information retrieval services, entertainment services, and transportation services.

33. A method according to any of claims 1-3 and 30-32 and wherein said selecting and completing are effected in a single user action.

34. A method according to any of claims 1-3 and 30-104 and wherein said selecting and completing are effected in multiple user actions.

35. A method according to any of claims 7-26, 29, 34, 39, 45, 46 and 48 and wherein said non-numerical non-direction control is a select control.

36. A method according to any of claim 10-15 and wherein said acquisition is a purchase transaction.

37. A method according to any of claims 10-15 and wherein said acquisition is a non-purchase transaction.

38. A method according to any of claims 12-15 and wherein said provider's priorities are based on economic benefit to said provider.

39. A method according to any of claims 12-15 and 38 and wherein said provider's priorities are based on an expected statistical preference of the user.
